(19) United States
(12) Patent Application Publication
(10) Pub. No.: US 2017/0074198 A1
(43) Pub. Date: Mar. 16, 2017

(54) ABNORMALITY DETERMINATION DEVICE

(71) Applicant: HONDA MOTOR CO., LTD., Tokyo (JP)

(72) Inventors: Ikue HABU, Wako-shi, Saitama (JP); Masato AMANO, Wako-shi, Saitama (JP)

(21) Appl. No.: 15/311,293

(22) PCT Filed: Feb. 17, 2015
(86) PCT No.: PCT/JP2015/054206

§ 371 Date: Nov. 15, 2016

(30) Foreign Application Priority Data
May 20, 2014 (JP) 2014-103991

(51) Int. Cl. F02D 41/22; F02D 41/26; F02M 25/08; F02D 41/00

(52) U.S. Cl. CPC F02D 41/221; F02D 41/0032; F02D 41/26; F02M 25/0809

(57) ABSTRACT

An abnormality determination device which is capable of shortening a time period required for performing abnormality determination of a plurality of devices, in a state in which the supply of evaporated fuel to an intake system is stopped, as a whole, thereby making it possible to increase the frequency of execution of the determination, and improve the throughput of an evaporated fuel processor for processing evaporated fuel. When first and second execution conditions are satisfied, respectively, first and second determination operations for determining the abnormalities of first and second devices, respectively, are performed in the state in which the supply of evaporated fuel is stopped. In a case where the first determination operation is completed, when the second execution condition has been satisfied, the second determination operation is started with the supply of evaporated fuel being held in the stopped state.

### TECHNICAL FIELD

This invention relates to an abnormality determination device that determines abnormalities of a plurality of devices including an internal combustion engine and other devices provided in association with the internal combustion engine.

### BACKGROUND ART

Conventionally, as an abnormality determination device of this kind, there has been known one disclosed e.g. in PTL 1. In this abnormality determination device, an abnormality of each of an EGR device, an evaporated fuel processor, and a catalytic device that are provided in an internal combustion engine as a motive power source of a vehicle is determined when a predetermined determination condition set therefor is satisfied, and the satisfaction of each determination condition is determined in the order of the EGR device, the evaporated fuel processor, and the catalytic device. Further, in a case where an abnormality of one of the three devices is being determined, when the determination condition of another device is satisfied, it is determined whether to continue the determination in progress or to determine an abnormality of the device associated with the satisfied determination condition, based on the degrees of priority of the determinations. That is, if the degree of priority of the abnormality determination in progress is lower, the abnormality determination is suspended to determine the abnormality of the device associated with the determination condition satisfied later. Inversely, if the degree of priority of the abnormality determination in progress is higher, the abnormality determination is continued.

More specifically, the degrees of priority of the abnormality determination of the EGR device and the evaporated fuel processor are set to be higher than that of the catalytic device, and even when the determination condition of the catalytic device is satisfied during abnormality determination of the EGR device or the evaporated fuel processor, the abnormality determination of the EGR device or the evaporated fuel processor is continued without being suspended. Inversely, when the determination condition of the EGR device or the evaporated fuel processor is satisfied during abnormality determination of the catalytic device, the abnormality determination of the catalytic device is suspended, and the abnormality determination of one of the EGR device and the evaporated fuel processor, of which the determination condition has been satisfied, is started. Further, as for the respective abnormality determinations of the EGR device and the evaporated fuel processor, abnormality determination of one, of which the determination condition has been satisfied earlier, is started earlier, and is completed without being suspended. This is for positively performing the abnormality determination of the EGR device of which the determination condition is difficult to be satisfied, and positively completing the abnormality determination thereof without unnecessarily discharging fuel trapped by the evaporated fuel processor.

### CITATION LIST

### Patent Literature

[PTL 1] Japanese Laid-Open Patent Publication (Kokai) No. H04-238241

### SUMMARY OF INVENTION

### Technical Problem

The engine is provided with not only the above-mentioned EGR device and the like, but also a plurality of devices, such as sensors, and the plurality of devices include one for determining an abnormality of the evaporated fuel processor in a state in which the supply of evaporated fuel from the evaporated fuel processor to an intake system of the engine is stopped (hereinafter referred to as the “purge cut”). In a case where there are provided a plurality of devices of which abnormalities are determined in a purge cut state (hereinafter referred to as the “purge cut determination devices”), when the abnormalities of the plurality of purge cut determination devices are sequentially determined by the above-described conventional abnormality determination device, there occur the following inconveniences:

In the conventional abnormality determination device, the continuation/suspension of the abnormality determination of each of the plurality of devices is simply determined based on the degrees of priority of the abnormality determination of the devices, as described above. Therefore, the supply of evaporated fuel is sometimes temporarily resumed during time from the completion of abnormality determination of a single purge cut determination device to determination of an abnormality of a next purge cut determination device. In this case, abnormality determination of the next purge cut determination device has to be held until the amount of supplied evaporated fuel is stabilized to 0 by the purge cut, whereby a time period required for the determination becomes longer as a whole, which results in reduction of the frequency of execution of the abnormality determination of the plurality of purge cut determination devices. For the same reason, an execution time period of the purge cut becomes longer, whereby the amount of evaporated fuel remaining in the evaporated fuel processor is increased, which results in degradation of the throughput thereof.

The present invention has been made to provide a solution to the above-described problems, and an object thereof is to provide an abnormality determination device which is capable of shortening a time period required for abnormality determination of a plurality of devices, as a whole, which is performed in a state in which the supply of evaporated fuel to an intake system is stopped, thereby making it possible to increase the frequency of execution of the determination, and improve the throughput of an evaporated fuel processor for processing evaporated fuel.

### Solution to Problem

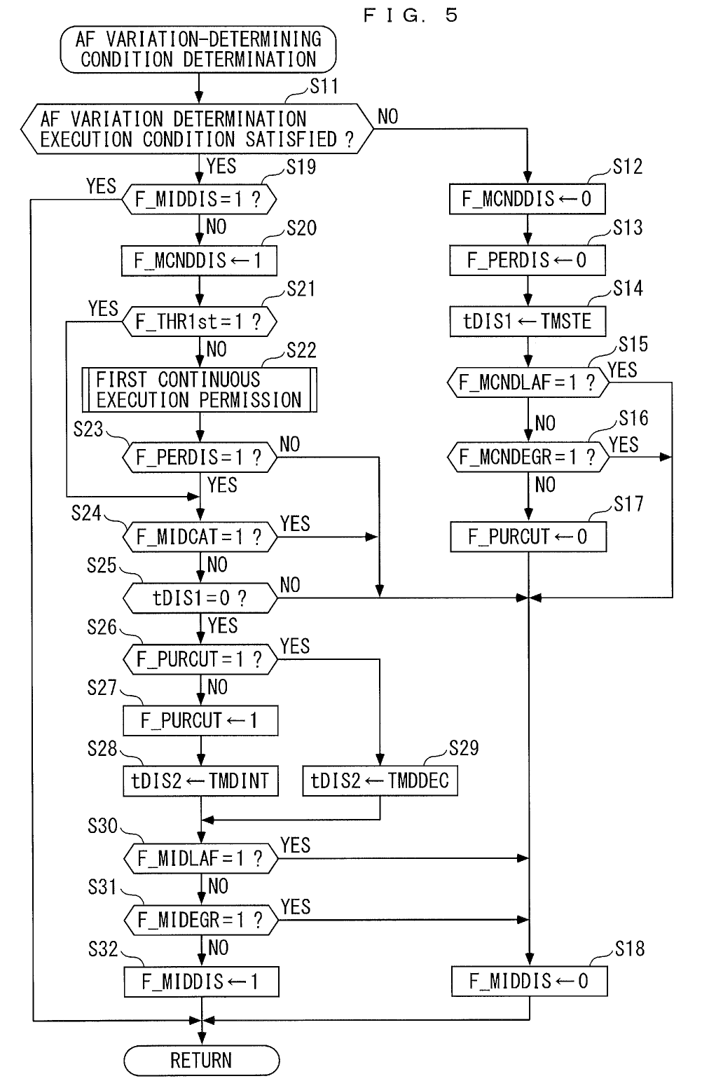

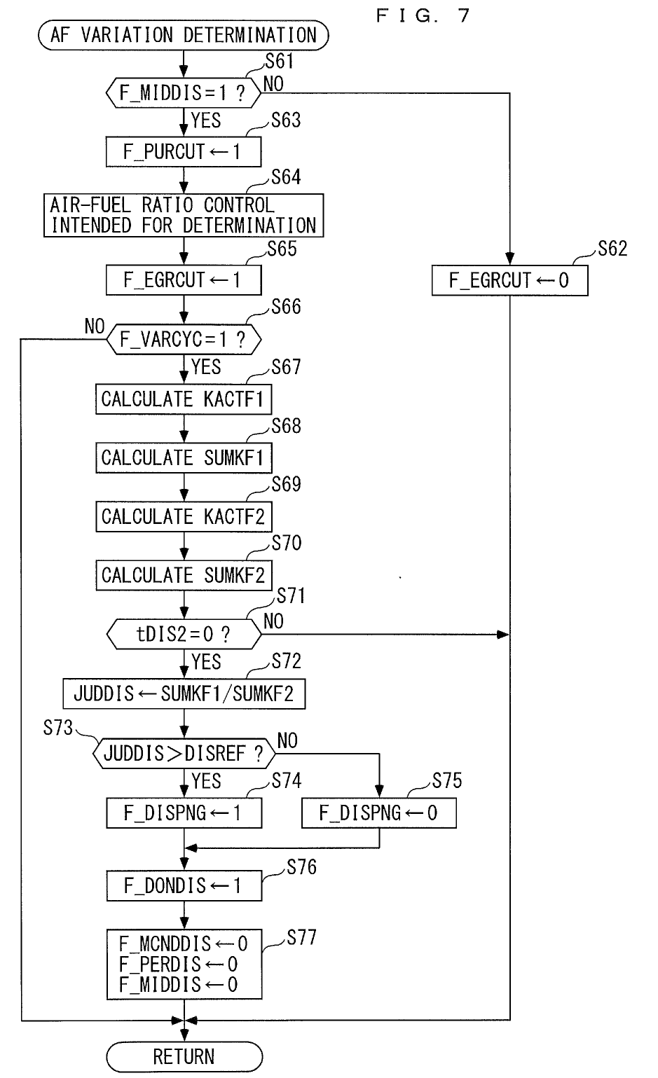

To attain the above object, the invention according to claim 1 is an abnormality determination device for determining abnormalities of a plurality of devices including an internal combustion engine 3 provided with an evaporated fuel processor 31 that traps evaporated fuel generated in a fuel tank FT and supplies the trapped evaporated fuel to an intake system (intake passage 21 in the embodiment (hereinafter, the same applies throughout this section)) of the engine, and other devices (EGR device 51, LAF sensor 66, three-way catalyst 28) provided in association with the engine 3, comprising first determination means (ECU 2, FIG. 5, FIGS. 7 to 11) for performing a first determination operation for determining an abnormality of a first device (engine 3, EGR device 51, LAF sensor 66) of the plurality of devices, in a state in which the supply of evaporated fuel by the evaporated fuel processor 31 is stopped, when a predetermined first execution condition is satisfied, and second determination means (ECU 2, FIG. 5, FIGS. 7 to 11) for performing a second determination operation for determining an abnormality of a second device (engine 3, EGR device 51, LAF sensor 66) of the plurality of devices, distinct from the first device, in the state in which the supply of evaporated fuel by the evaporated fuel processor 31 is stopped, when a predetermined second execution condition is satisfied, wherein in a case where the first determination operation is completed, when the second determination condition has been satisfied, the second determination means starts the second determination operation, with the supply of evaporated fuel being held in the stopped state (FIG. 5, FIGS. 7 to 11).

With this configuration, when the predetermined first and second execution conditions are satisfied, respectively, the first and second determination operations for determining abnormalities of the first and second devices, respectively, are performed in the state in which the supply of evaporated fuel is stopped. Hereinafter, the stop of the supply of evaporated fuel is referred to as the “purge cut”).

Further, in the case where the first determination operation is completed, when the second determination condition has been satisfied, the second determination operation is started with the supply of evaporated fuel being held in the stopped state. With this, differently from the above-described conventional case, the supply of evaporated fuel is prevented from being resumed after the completion of the first determination operation until the start of the second determination operation, so that it is not required to hold determination until the amount of supply of evaporated fuel is stabilized to 0 by the purge cut, and therefore it is possible to determine the abnormality of the second device soon. This makes it possible to shorten a time period required for determining abnormalities of the plurality of devices in a purge cut state, as a whole, thereby making it possible to increase frequency of execution of the determination, and improve the throughput of the evaporated fuel processor for processing evaporated fuel.

Note that in the description and claims of the present application, the term “abnormality” refers to “not being normal”, and includes “failure”, “deterioration”, and the like.

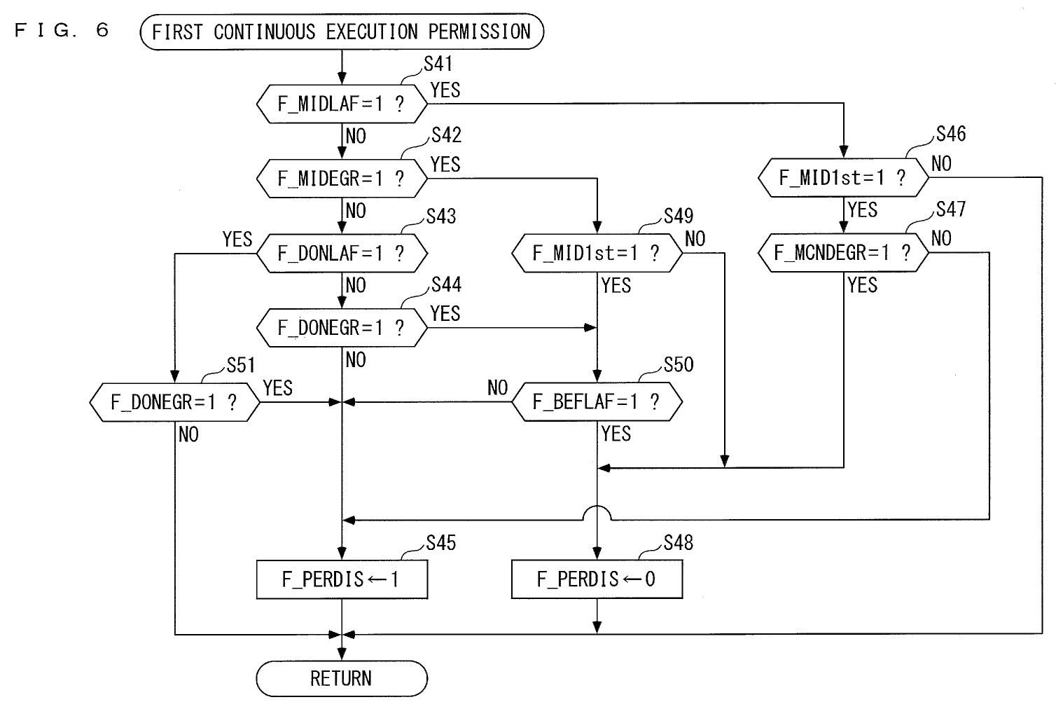

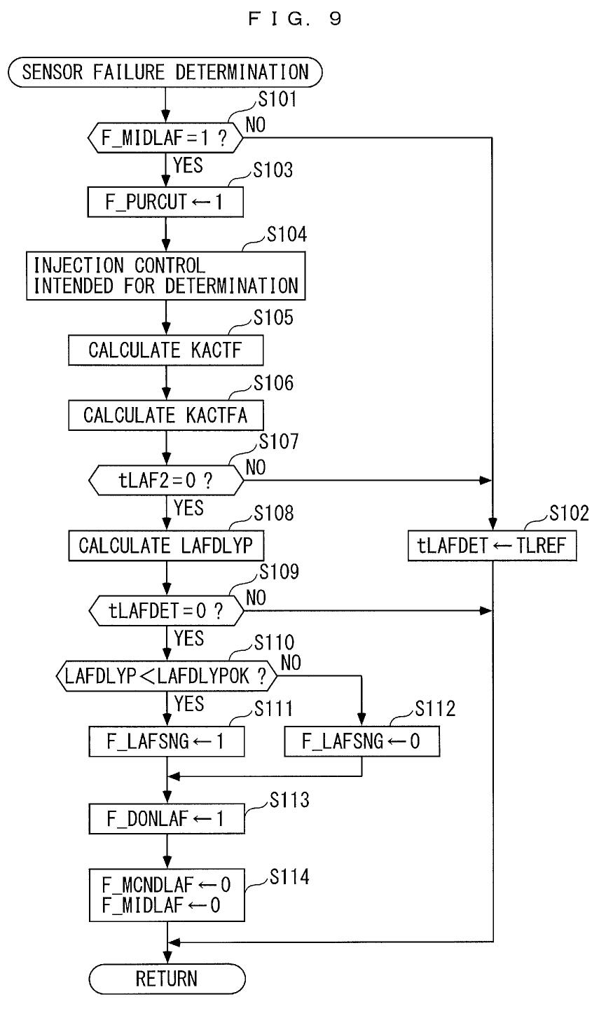

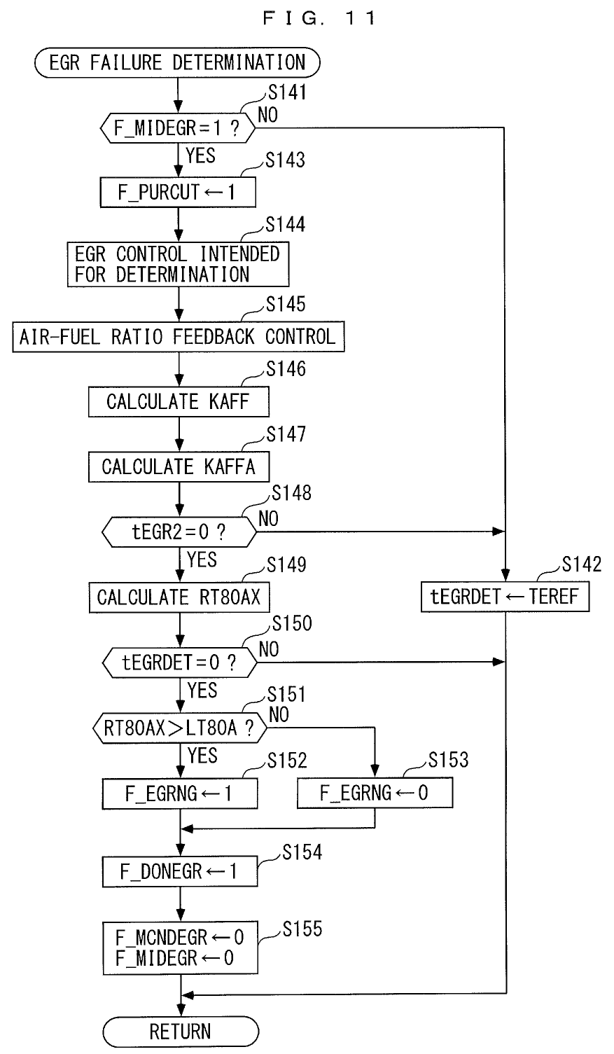

The invention according to claim 2 is the abnormality determination device according to claim 1, wherein the second device is formed by a plurality of second devices distinct from each other, wherein a plurality of second execution conditions different from each other are set for the plurality of second devices, respectively, as the second execution condition, wherein a plurality of second determination operations different from each other are set for the plurality of second devices, respectively, as the second determination operation, each of the plurality of second determination operations including a control operation for controlling the engine 3 (steps 64 and 65 in FIG. 7, step 104 in FIG. 9, steps 144 and 145 in FIG. 11), and wherein during execution of the first determination operation, when all of the plurality of second execution conditions are satisfied, the second determination means selects the second device of which an abnormality is to be determined following the completion of the first determination operation, from the plurality of second devices, based on the plurality of second execution conditions and the plurality of second determination operations (steps 22 and 23 in FIG. 5, FIG. 6).

With this configuration, the second device is formed by the plurality of second devices distinct from each other, and the plurality of second execution conditions different from each other are set for the plurality of second devices, respectively, as the second determination condition. Further, the plurality of second determination operations different from each other are set for the plurality of second devices, respectively, as the second determination operation, and each of the plurality of second determination operations includes the control operation for controlling the engine.

For this reason, in a case where each of the plurality of second execution conditions includes predetermined conditions concerning an operating state of the engine, different from each other, when one of the plurality of second devices is selected as desired, and one of the second determination operations, associated with the selected second device, is executed following the completion of the first determination operation, the second execution conditions associated with the other second devices sometimes cease to be satisfied during execution of the second determination operation. In this case, it is impossible to sequentially and continuously execute the second determination operations associated with the plurality of second devices, whereby the supply of evaporated fuel is resumed, which can make it impossible to shorten a time period required for determining the abnormalities of the plurality of second devices as a whole.

With the above-described configuration, during execution of the first determination operation, when all of the plurality of second execution conditions are satisfied, the second device of which the abnormality is to be determined following the completion of the first determination operation is selected from the plurality of second devices based on the plurality of second execution conditions and the plurality of second determination operations. With this, as the second device of which the abnormality is to be determined following the completion of the first determination operation, it is possible to select one during execution of the second determination operation of which a second execution condition associated with another second determination operation is satisfied. This makes it possible to sequentially and continuously execute the plurality of second determination operations, and hence it is possible to shorten a time period required for determining the abnormalities of the plurality of second devices as a whole.

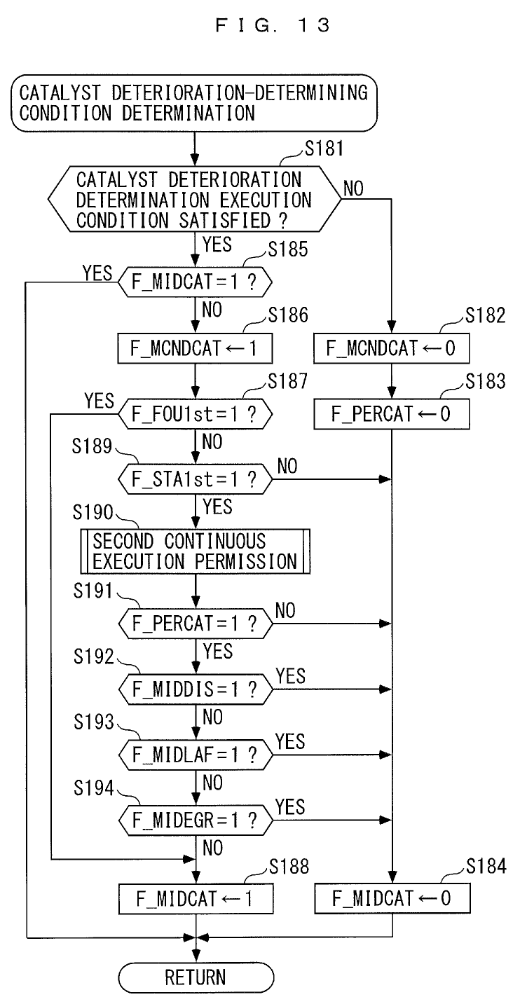

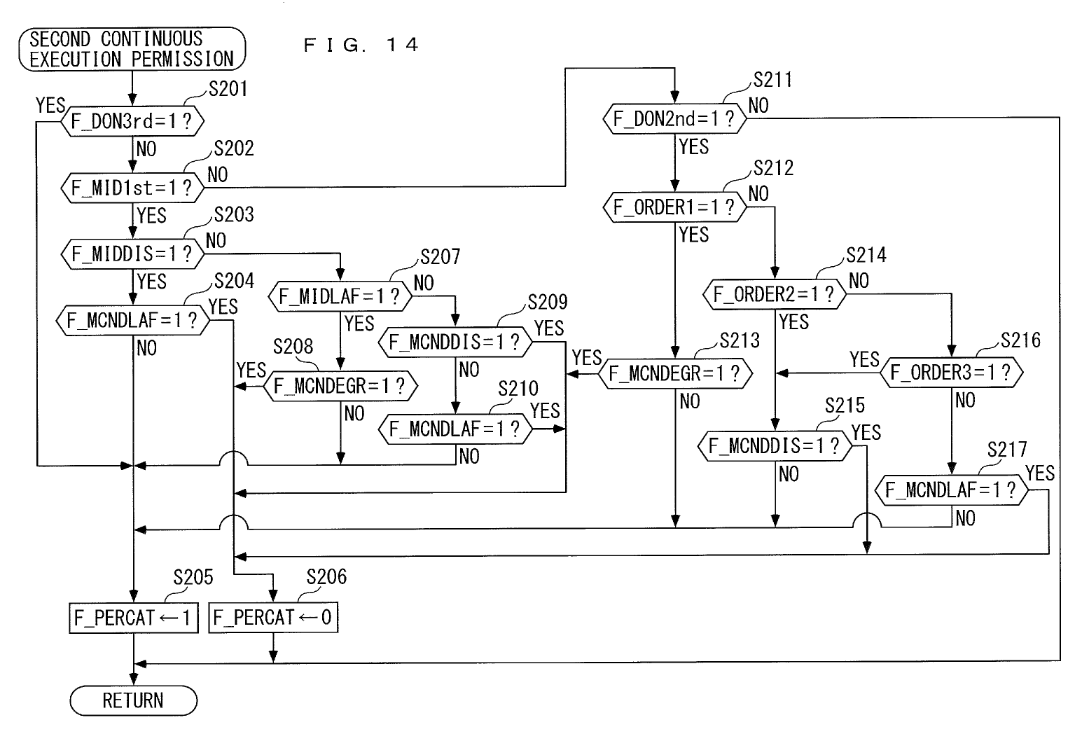

The invention according to claim 3 is the abnormality determination device according to claim 1 or 2, further comprising third determination means (ECU 2, FIGS. 13 to 15) for performing a third determination operation for determining an abnormality of a third device (three-way catalyst 28) of the plurality of devices, distinct from the first and second devices, when a predetermined third execution condition is satisfied, and inhibition means (ECU 2, steps 190 and 191 in FIG. 13, FIG. 14) for inhibiting the third determination operation from being executed continuously from the completion of the first determination operation in order to give priority to the second determination operation, when both of the second and third execution conditions have been satisfied during execution of the first determination operation.

With this configuration, when the predetermined third execution condition is satisfied, the third determination operation for determining the abnormality of the third device distinct from the first and second devices is performed. Further, during execution of the first determination operation, when both of the second and third execution conditions have been satisfied, the third determination operation is inhibited from being executed continuously from the completion of the first determination operation in order to give priority to the second determination operation. As a consequence, following the completion of the first determination operation requiring the purge cut, it is possible to perform the second determination operation also requiring the purge cut, so that it is possible to effectively obtain the same advantageous effect of the invention according to claim 1, that is, the advantageous effect that it is possible to shorten the time period required for determining the abnormalities of the plurality of devices in the purge cut state, as a whole.

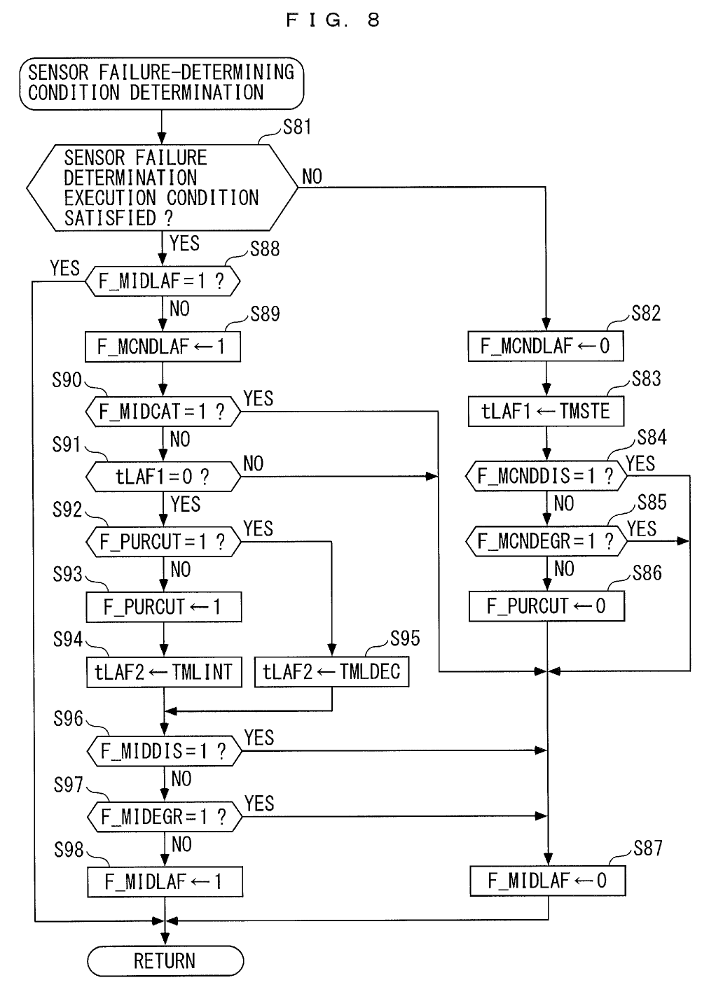

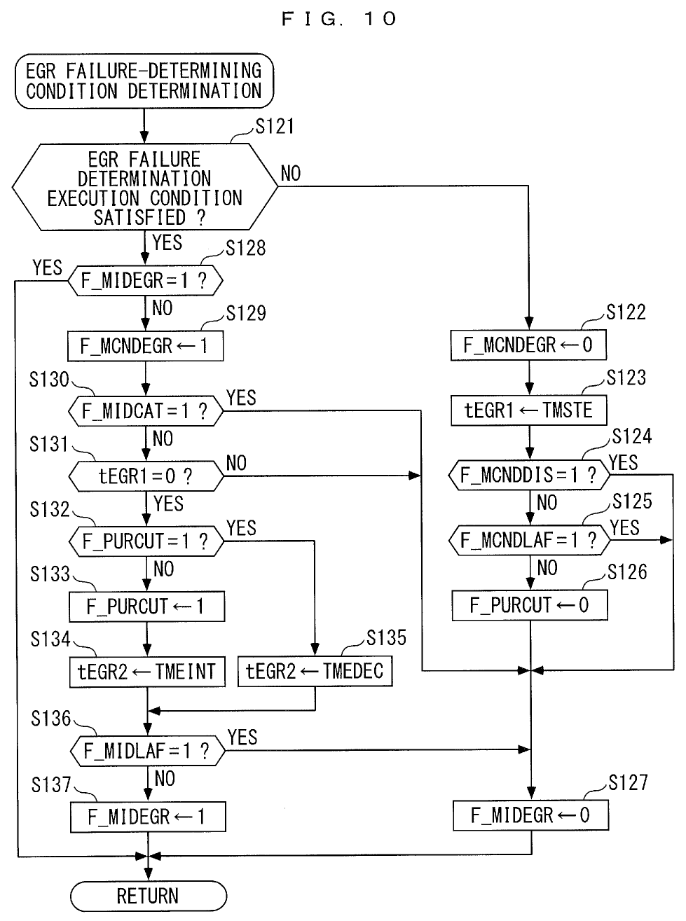

The invention according to claim 4 is the abnormality determination device according to any one of claims 1 to 3, further comprising determining parameter acquisition means (ECU 2, step 72 in FIG. 7, step 108 in FIG. 9, step 149 in FIG. 11) for acquiring a determining parameter (AF variation-determining parameter JUDDIS, integral value LAFDLYP, integral value RT80AX) for determining an abnormality of each of the plurality of devices, wherein the second determination means determines an abnormality of the second device based on the acquired determining parameter (steps 73 to 75 in FIG. 7, steps 110 to 112 in FIG. 9, steps 151 to 153 in FIG. 11) after the lapse (YES to step 71 in FIG. 7, YES to step 107 in FIG. 9, YES to step 148 in FIG. 11) of a predetermined wait time (initial wait time TMDINT, initial wait time TMLINT, initial wait time TMEINT, reduced wait time TMDDEC, reduced wait time TMLDEC, reduced wait time TMEDEC) after a start of the second determination operation, and reduces the wait time when the second determination operation is executed following the completion of the first determination operation (steps 26 135 and 29 in FIG. 5, steps 92 and 95 in FIG. 8, steps 132 and 135 in FIG. 10).

With this configuration, the abnormality of the second device is determined based on the acquired determining parameter after the lapse of the predetermined wait time after the start of the second determination operation. As stated in the description of the invention according to claim 1, when the second determination operation is executed continuously from the completion of the first determination operation, differently from the above-described conventional case, there is no need to hold determination until the amount of supply of evaporated fuel is stabilized to 0 by the purge cut, and hence it is possible to reduce the wait time accordingly. With the above-described configuration, when the second determination operation is executed following the completion of the first determination operation, the above-mentioned wait time is reduced, and hence it is possible to effectively obtain the same advantageous effect of the invention according to claim 1, that is, the advantageous effect that it is possible to shorten the time period required for determining the abnormalities of the plurality of devices in the purge cut state, as a whole.

Note that in the description and claims of the present application, the term “acquisition” includes not only detection by sensors but also “calculation” by computation and “setting”.

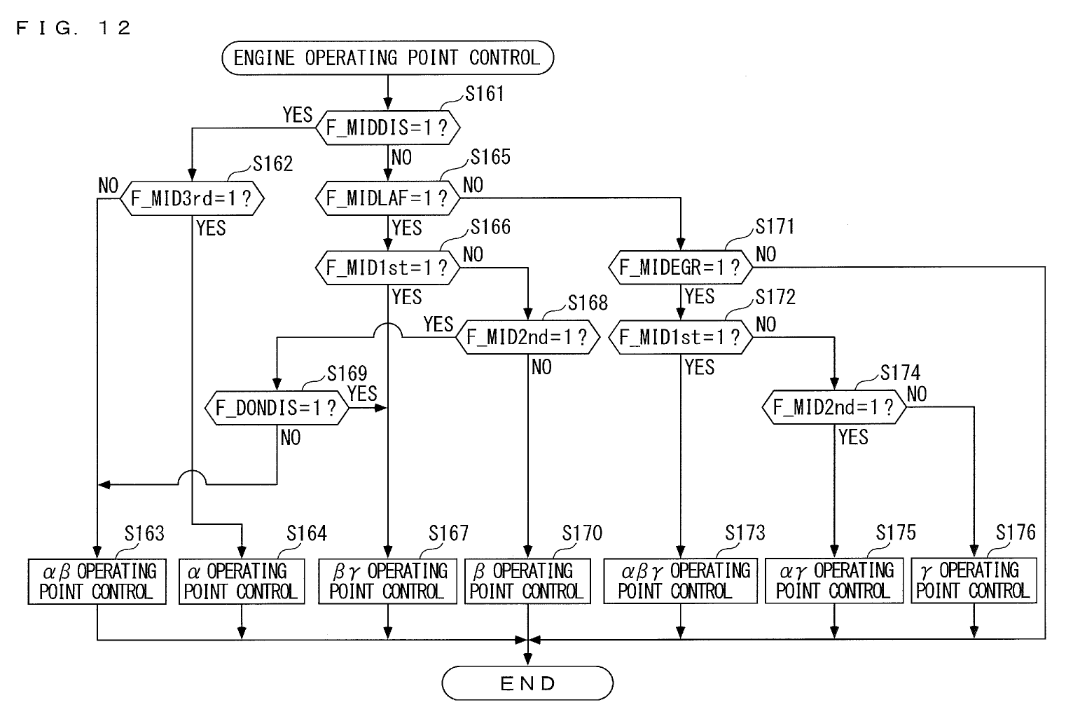

The invention according to claim 5 is the abnormality determination device according to any one of claims 1 to 4, wherein an electric motor (first motor 4, second motor 5) that forms motive power sources together with the engine 3 is connected to the engine 3, wherein the first and second execution conditions include predetermined first and second engine operating conditions concerning a operating state of the engine 3, different from each other, respectively, and wherein during execution of the first determination operation, the second determination means controls the engine 3 such that not only the first engine operating condition but also the second engine operating condition is satisfied (steps 163, 167, 173, and 175 in FIG. 12).

With this configuration, the predetermined first and second engine operating conditions concerning the operating state of the engine are included in the first and second execution conditions, respectively. Further, during execution of the first determination operation, the engine is controlled such that not only the first engine operating condition but also the second engine operating condition is satisfied, and hence it is possible to increase the possibility of the second determination operation being executed following the completion of the first determination operation, which in turn makes it possible to effectively obtain the same advantageous effect of the invention according to claim 1, that is, the advantageous effect that it is possible to shorten the time period required for determining the abnormalities of the plurality of devices in the purge cut state, as a whole.

In this case, the electric motor that forms the motive power sources together with the engine is connected to the engine. Therefore, in a case where the output of the engine controlled as described above is insufficient for a desired output, the insufficient amount is compensated for by the electric motor, whereas in a case where the output of the engine is surplus with respect to the desired output, the surplus amount can be consumed by power generation by the electric motor, whereby it is possible to ensure excellent drivability.

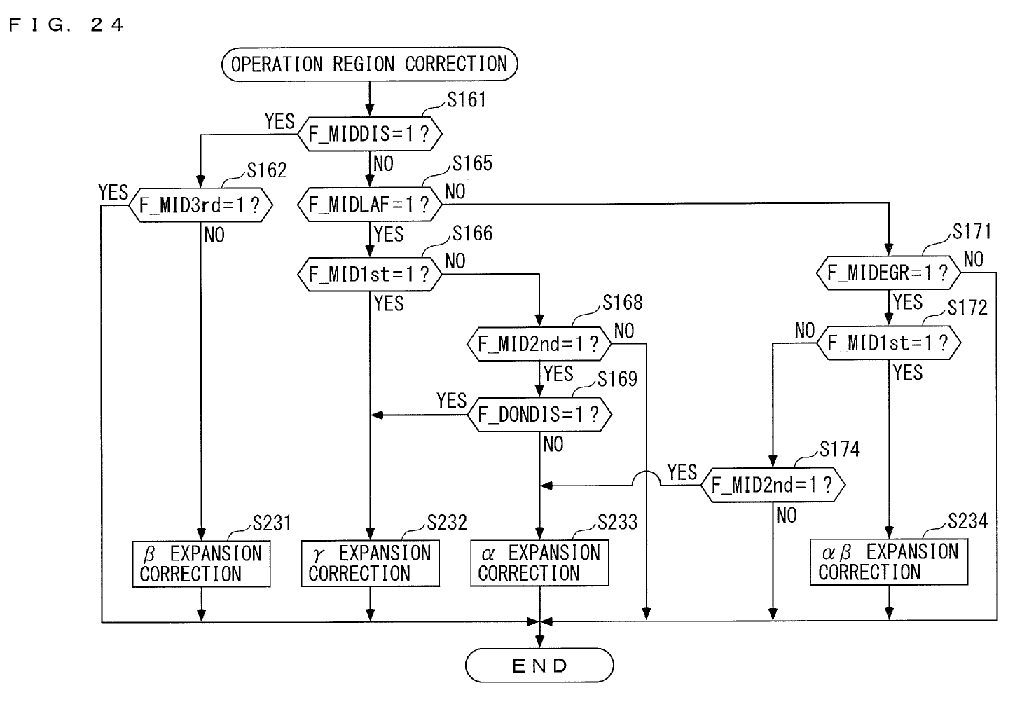

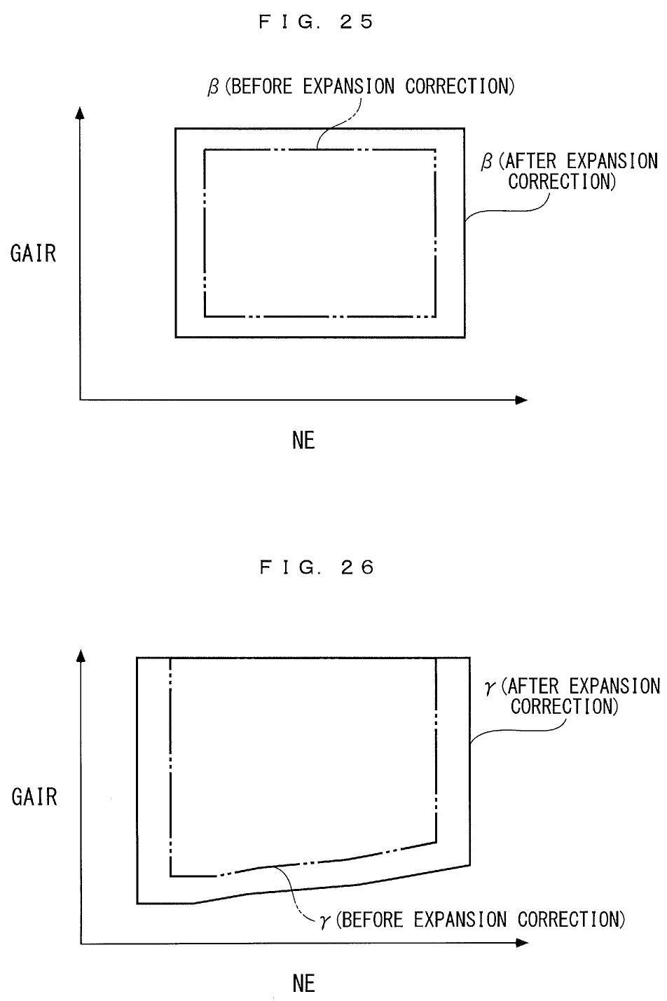

The invention according to claim 6 is the abnormality determination device according to any one of claims 1 to 4, wherein during execution of the first determination operation, the second determination means loosens the second execution condition (steps 231 to 2324 in FIG. 24, FIGS. 25 to 27).

With this configuration, since the second execution condition as an execution condition for the second determination operation is loosened during execution of the first determination operation, the second execution condition is made easier to be satisfied, so that it is possible to increase the possibility that the first and second determination operations are sequentially and continuously executed. This makes it possible to effectively obtain the same advantageous effect of the invention according to claim 1, that is, the advantageous effect that it is possible to shorten the time period required for determining the abnormalities of the plurality of devices in the purge cut state, as a whole.

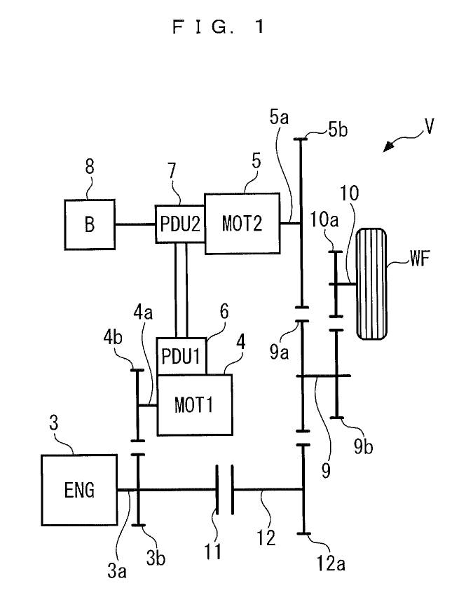

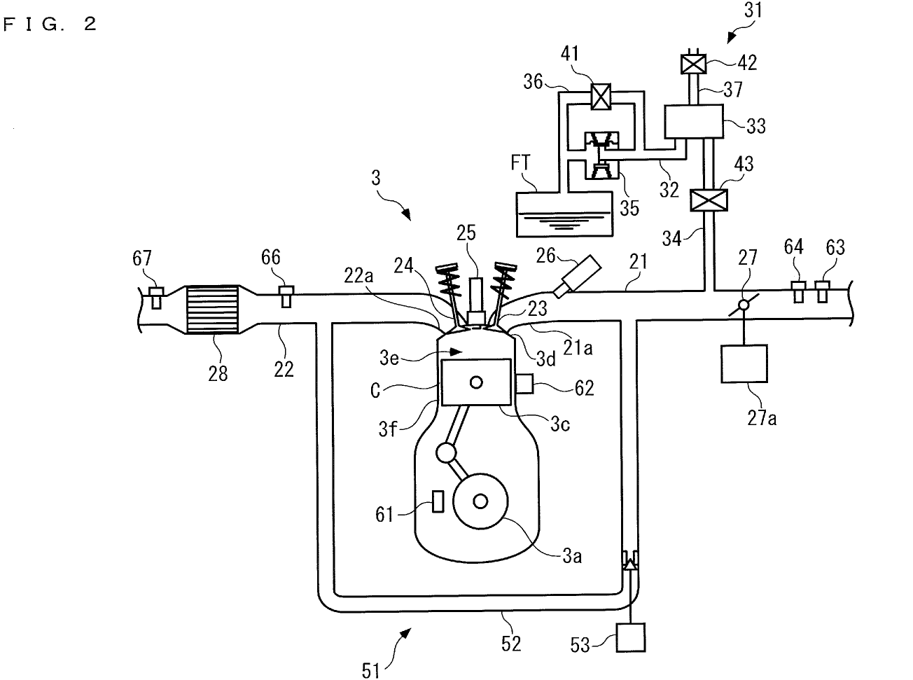

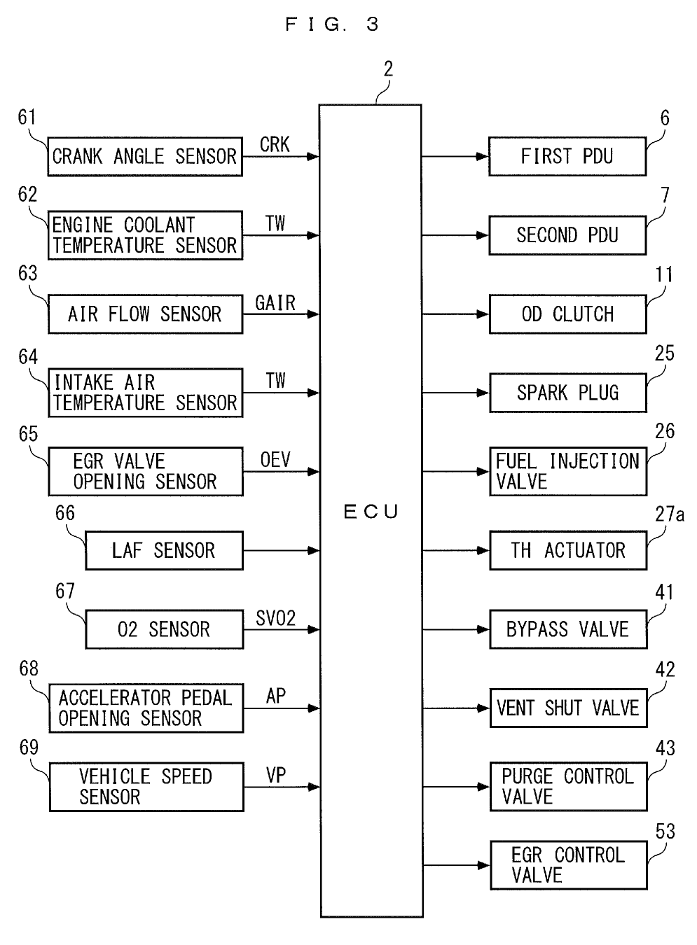

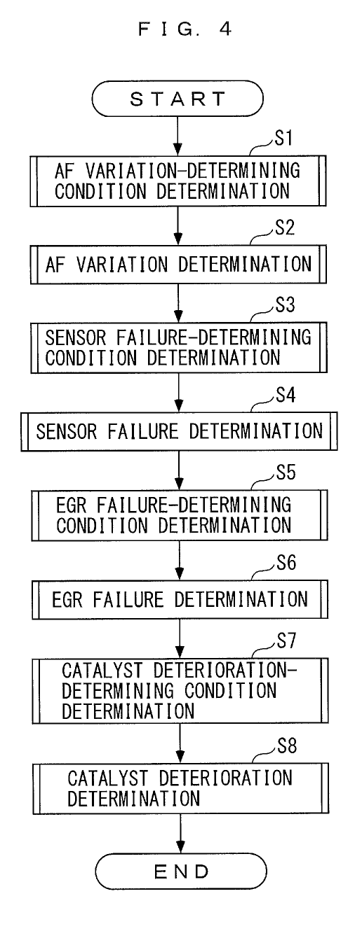

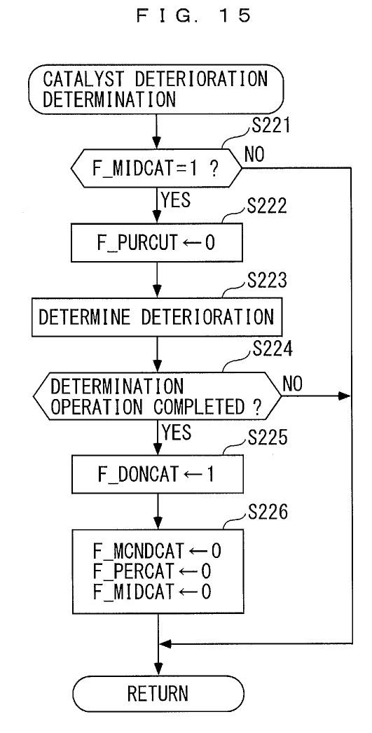

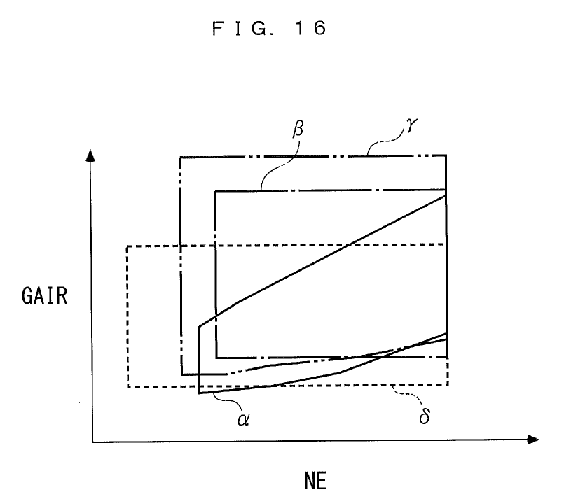

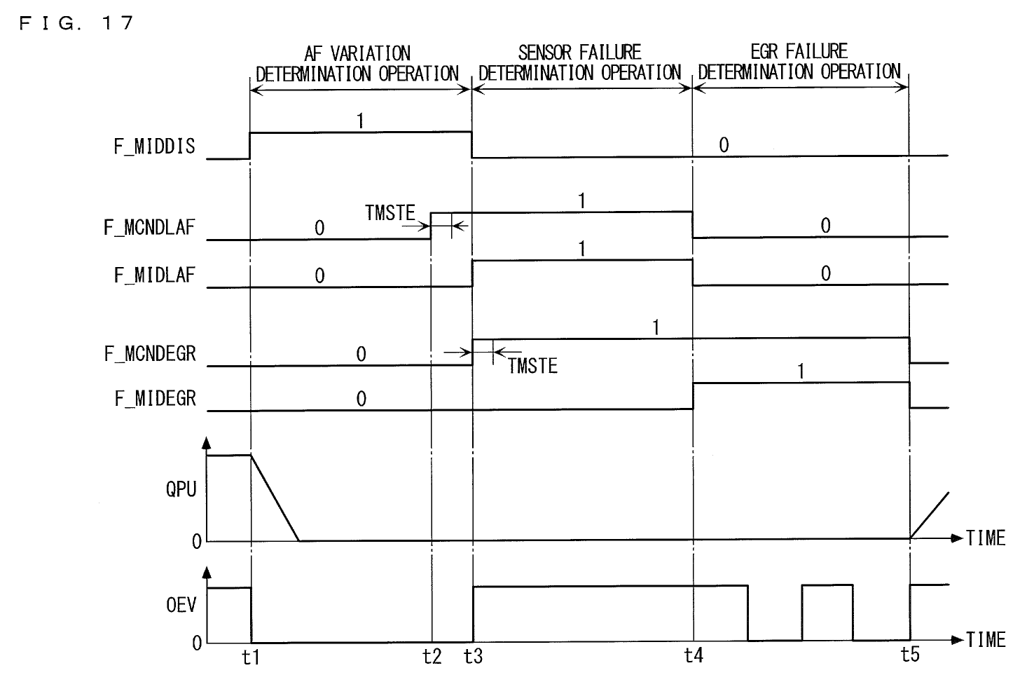

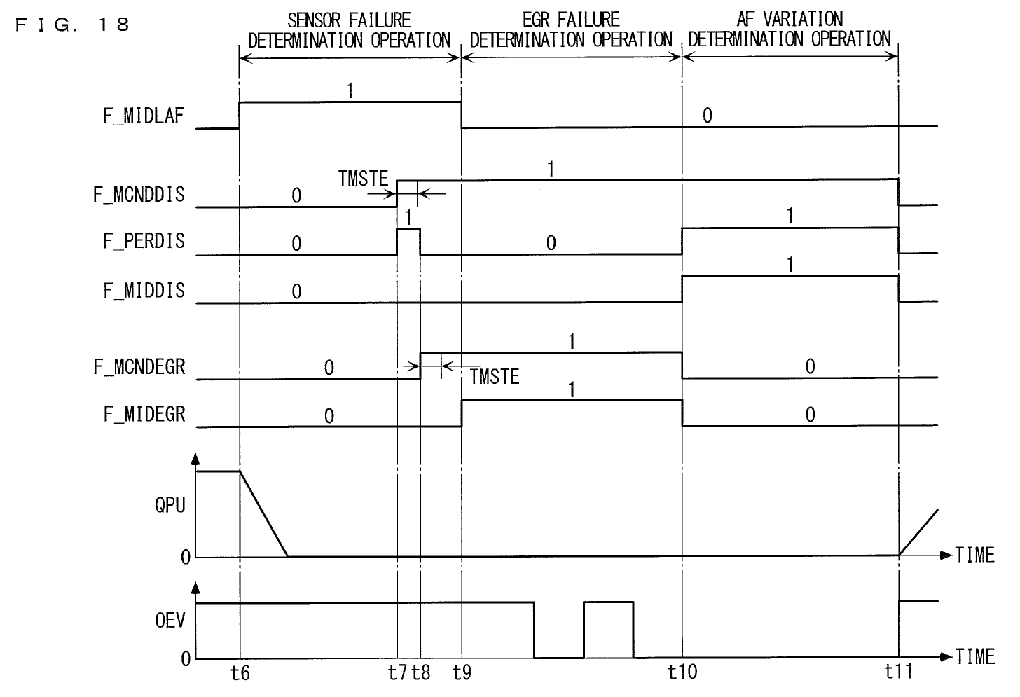

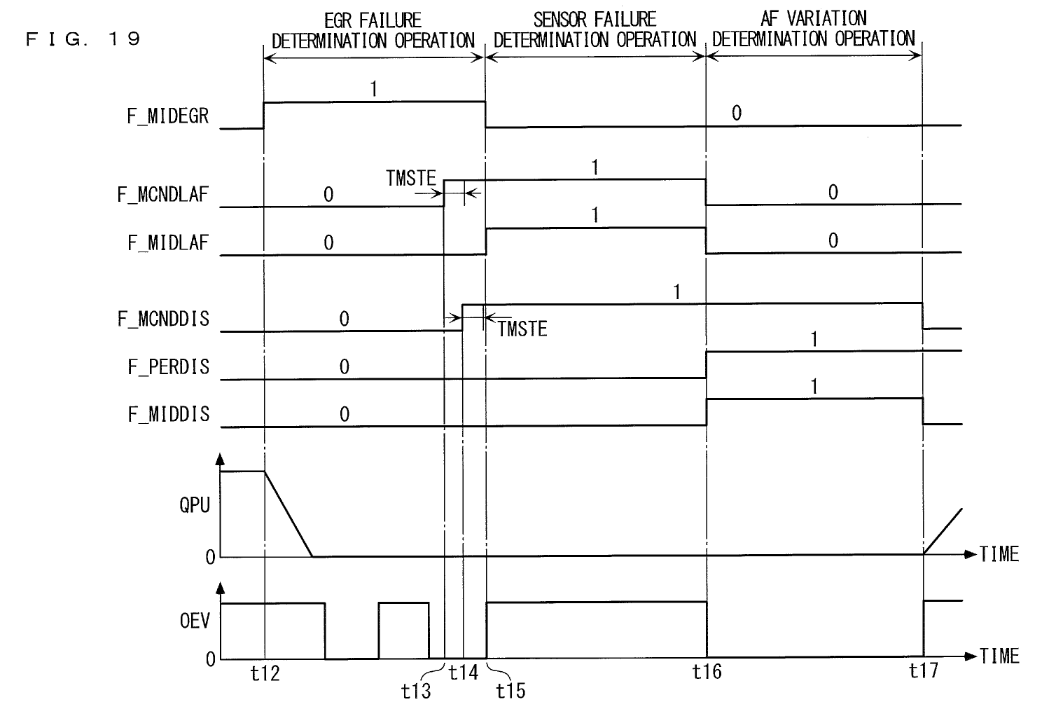

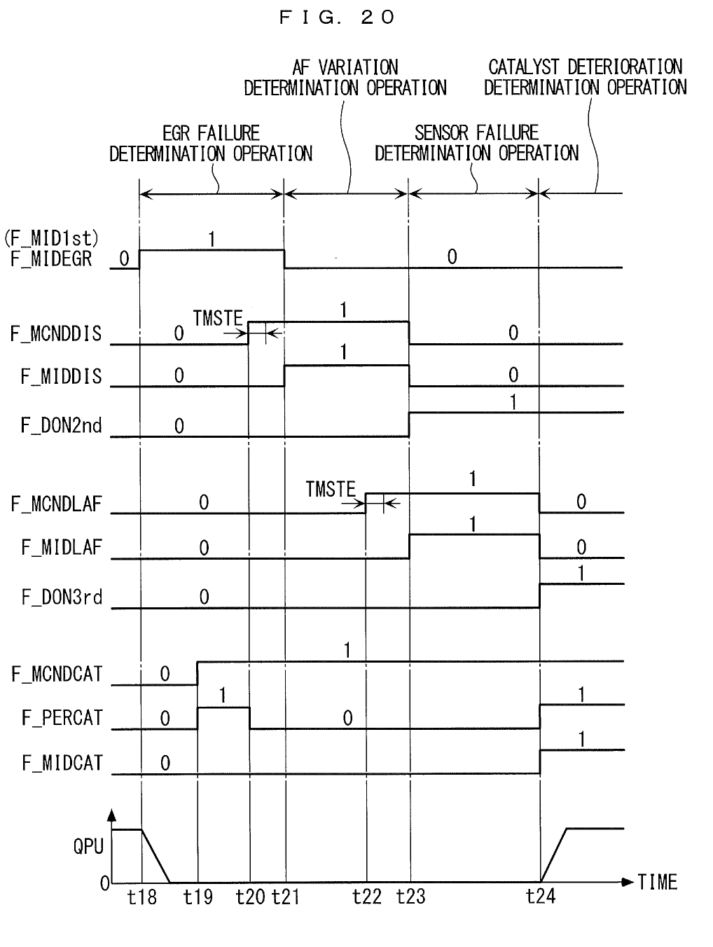

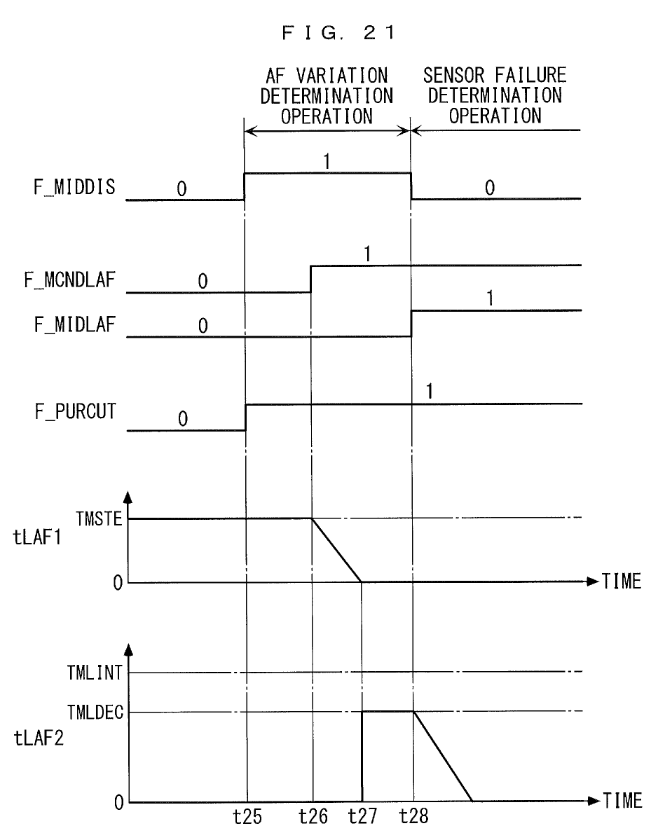

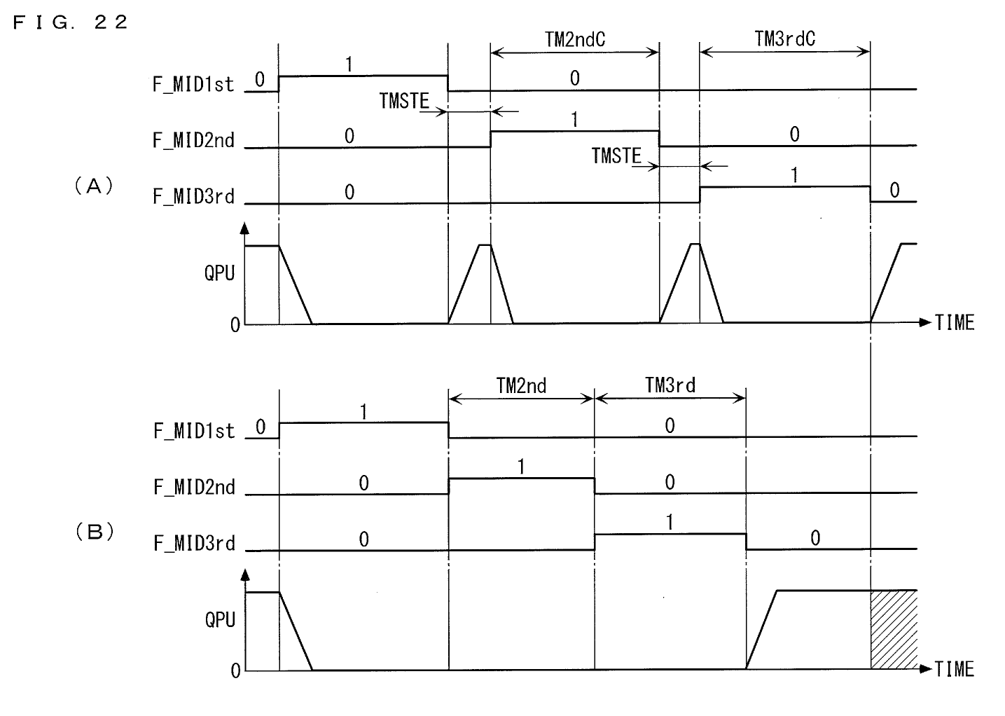

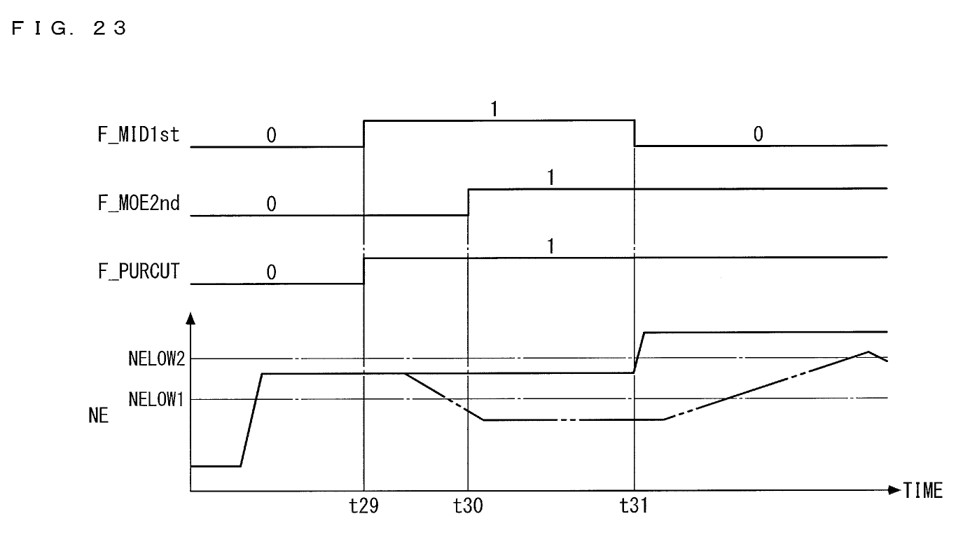

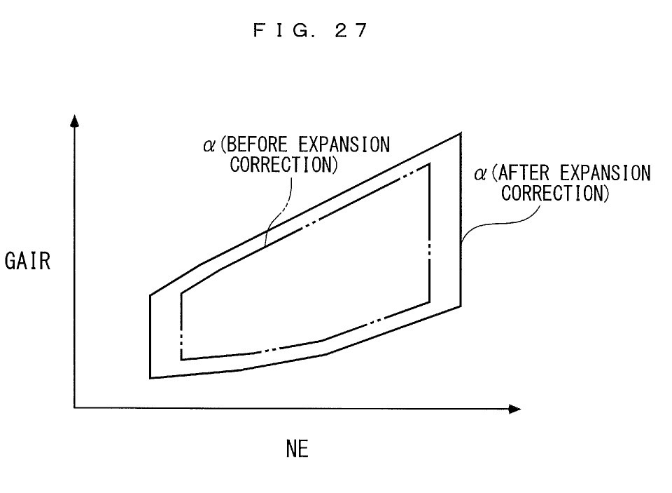

### BRIEF DESCRIPTION OF DRAWINGS

[FIG. 1] A diagram schematically showing a vehicle to which is applied an abnormality determination device according to a first embodiment of the present invention.

[FIG. 2] A diagram schematically showing an internal combustion engine etc. provided in the vehicle.

[FIG. 3] A block diagram of an ECU etc. of the abnormality determination device.

[FIG. 4] A flowchart of a process performed by the ECU.

[FIG. 5] A flowchart of a subroutine for an AF variation-determining condition determination process performed in the process shown in FIG. 4.

[FIG. 6] A flowchart of a subroutine for a first continuous execution permission process performed in the AF variation-determining condition determination process.

[FIG. 7] A flowchart of a subroutine for an AF variation determination process performed in the process shown in FIG. 4.

[FIG. 8] A flowchart of a subroutine for a sensor failure-determining condition determination process performed in the process shown in FIG. 4.

[FIG. 9] A flowchart of a subroutine for a sensor failure determination process performed in the process shown in FIG. 4.

[FIG. 10] A flowchart of a subroutine for an EGR failure-determining condition determination process performed in the process shown in FIG. 4.

[FIG. 11] A flowchart of a subroutine for an EGR failure determination process performed in the process shown in FIG. 4.

[FIG. 12] A flowchart of an engine operating point control process.

[FIG. 13] A flowchart of a subroutine for a catalyst deterioration-determining condition determination process performed in the process shown in FIG. 4.

[FIG. 14] A flowchart of a subroutine for a second continuous execution permission process performed in the catalyst deterioration-determining condition determination process.

[FIG. 15] A flowchart of a subroutine for a catalyst deterioration determination process performed in the process shown in FIG. 4

[FIG. 16] A diagram of an operating point determination map used in the processes shown in FIGS. 5, 8, and 10.

[FIG. 17] A timing diagram showing an example of operation performed by the abnormality determination device.

[FIG. 18] A timing diagram showing an example of operation different from the example shown in FIG. 17.

[FIG. 19] A timing diagram showing an example of operation different from the examples shown in FIGS. 17 and 18.

[FIG. 20] A timing diagram showing an example of operation different from the examples shown in FIGS. 17 to 19.

[FIG. 21] A timing diagram showing an example of changes in timer values of first and second wait timers, etc.

[FIG. 22] A diagram showing (A) an example of changes in a purge flow rate and so forth during execution of a determination operation by the abnormality determination device according to the first embodiment, together with (B) a comparative example.

[FIG. 23] A timing diagram showing an example of operation by a variation of the first embodiment.

[FIG. 24] A flowchart of an operating region correction process performed by an abnormality determination device according to a second embodiment of the present invention.

[FIG. 25] A diagram of a region β (two-dot chain line) before being corrected for expansion and the region β (solid line) after being corrected for expansion.

[FIG. 26] A diagram of a region γ (two-dot chain line) before being corrected for expansion and the region γ (solid line) after being corrected for expansion.

[FIG. 27] A diagram of a region α (two-dot chain line) before being corrected for expansion and the region α (solid line) after being corrected for expansion.

### DESCRIPTION OF EMBODIMENTS

The invention will now be described in detail with reference to drawings showing preferred embodiments thereof. A hybrid vehicle (hereinafter simply referred to as the “vehicle”) V shown in FIG. 1 is a four-wheel vehicle comprised of an internal combustion engine (hereinafter referred to as the “engine”) 3, a first motor 4, and a second motor 5 as motive power sources, left and right front wheels WF (only one of which is shown) as drive wheels, and left and right rear wheels (not shown) as driven wheels.

Both the first and second motors 4 and 5 are so-called motor generators, and are formed e.g. by brushless DC motors. A stator (not shown) of the first motor 4 is electrically connected to a first power drive unit (hereinafter referred to as the “first PDU”) 6. Further, a stator (not shown) of the second motor 5 is electrically connected to a battery 8 via a second power drive unit (hereinafter referred to as the “second PDU”) 7.

The first and second PDUs 6 and 7 are formed by electric circuits, such as inverters, and are electrically connected to each other. Therefore, the first motor 4 and the second motor 5 are capable of inputting and outputting electric power to and from each other via the first and second PDUs 6 and 7. Further, the first and second PDUs 6 and 7 are controlled by control signals from an ECU 2, described hereinafter (see FIG. 3), whereby operations, such as powering or power generation by the first and second motors 4 and 5, and charging and discharging of the battery 8, are controlled.

A gear 4b provided on a rotating shaft 4a of the first motor 4 is in mesh with a gear 3b provided on a crankshaft 3a of the engine 3, and the engine 3 and the first motor 4 are capable of inputting and outputting motive power to and from each other via the gears 3b and 4b. Further, a gear 5b provided on a rotating shaft 5a of the second motor 5 is in mesh with a first gear 9a provided on a drive shaft 9, and a second gear 9b provided on the drive shaft 9 is in mesh with a final gear 10a provided on an axle 10 of the front wheels WF. With the above arrangement, the second motor 5 and the front wheels WF are capable of inputting and outputting motive power to and from each other e.g. via the above-mentioned gear 5b, first and second gears 9a and 9b, and final gear 10a.

Further, the crankshaft 3a of the engine 3 is connected to an intermediate shaft 12 via an OD clutch 11, and a gear 12a provided on the intermediate shaft 12 is in mesh with the above-mentioned first gear 9a. The OD clutch 11 is formed by an electromagnetic clutch, and engagement and disengagement thereof is controlled by a control signal from the ECU2 (see FIG. 3). Further, a gear ratio of the gear 12a on the intermediate shaft 12 and the first and second gears 9a and 9b on the drive shaft 9, to the final gear 10a is set to approximately 1:1. Therefore, in the engaged state of the OD clutch 11, the motive power of the engine 3 is transmitted from the crankshaft 3a to the front wheels WF via the above-mentioned gears at an approximately uniform rate.

With the above arrangement, the drive system of the vehicle V is operated in various operation modes by controlling the engine 3, the first and second motors 4 and 5, the OD clutch, and so forth. The operation modes are classified into an ECVT traveling mode, an ENG direct-connection traveling mode, an EV traveling mode, a decelerating power generation mode, and so forth. Hereinafter, a description will be sequentially given of these operation modes.

The ECVT traveling mode is a mode in which the vehicle V travels by generating electric power by the first motor 4 using motive power generated by the combustion of the engine 3, and driving the front wheels WF by powering of the second motor 5 while supplying the generated electric power to the second motor 5 (electrical path). In the ECVT traveling mode, by controlling the first and second PDUs 6 and 7, it is possible to steplessly change the speed of the motive power of the engine 3. Further, due to the nature of the first and second motors 4 and 5, high efficiency can be obtained by selecting the ECVT traveling mode in a low-to-medium speed region.

The ENG direct-connection traveling mode is a mode in which the vehicle V travels in the engaged state of the OD clutch 11 while transmitting the motive power of the engine 3 to the front wheels WF e.g. via the OD clutch 11 and the intermediate shaft 12 (mechanical path). As described above, the gear ratio between the OD clutch 11 and the front wheels WF is set to approximately 1:1, and by selecting the ENG direct-connection traveling mode in a high speed region, it is possible to obtain high efficiency. Note that the OD clutch 11 is disengaged in the other operation modes.

The EV traveling mode is a mode in which the vehicle V travels, in a state in which the operation of the engine 3 is stopped, by driving the front wheels WF by powering of the second motor 5 using electric power supplied from the battery 8.

The decelerating power generation mode is a mode in which the operation of the engine 3 is stopped, in a predetermined decelerating operating state of the vehicle V, by stopping fuel supply to the engine 3 (fuel cut), and electric power is generated by the second motor 5 using the kinetic energy of the vehicle V. In this case, a braking force acts on the vehicle V in accordance with the power generating operation of the second motor 5. Further, the electric power generated by the second motor 5 is charged into the battery 8 and is regenerated when the battery 8 in a further chargeable state. On the other hand, when the battery 8 is in a fully-charged state or the like, the electric power generated by the second motor 5 is supplied to the first motor 4 to perform motoring of the engine 3 by powering of the first motor 4, to be thereby converted to mechanical energy and heat energy.

Further, FIG. 2 shows the engine 3 and peripheral devices thereof to which is applied an abnormality determination device according to the first embodiment. The engine 3 is a gasoline engine having e.g. four cylinders C (only one of which is shown in FIG. 2). The crankshaft 3a of the engine 3 is provided with a crank angle sensor 61. The crank angle sensor 61 delivers a CRK signal, which is a pulse signal, to the ECU 2 along with rotation of the crankshaft 3a (see FIG. 3). Each pulse of the CRK signal is delivered whenever the crankshaft rotates through a predetermined crank angle (e.g. 1°). The ECU 2 calculates a rotational speed of the engine 3 (hereinafter referred to as the “engine speed”) NE based on the CRK signal.

A combustion chamber 3e is formed between a piston 3c and a cylinder head 3d of each cylinder C. An intake passage 21 and an exhaust passage 22 which communicate with the combustion chamber 3e are connected to the cylinder head 3d. An intake port 21a of the intake passage 21 and an exhaust port 22a of the exhaust passage 22 are provided with an intake valve 23 and an exhaust valve 24 for opening and closing the ports 21a and 22a, respectively. Further, a cylinder block 3f of the engine 3 is provided with an engine coolant temperature sensor 62. The engine coolant temperature sensor 62 detects a temperature of engine coolant circulating through the cylinder block 3f (hereinafter referred to as the “engine coolant temperature”) TW, and delivers a detection signal indicative of the detected engine coolant temperature TW to the ECU 2 (see FIG. 3).

Further, the engine 3 includes spark plugs 25 and fuel injection valves (hereinafter referred to as the “injectors”) 26 provided for the respective cylinders C. The spark plug 25 is mounted on the cylinder head 3d, and generates sparks to thereby ignite a mixture in the cylinder C. The injector 26 is mounted on an intake manifold of the intake passage 21, and injects fuel toward the intake port 21a. The ignition timing of the spark plug 25, and the fuel injection amount and fuel injection timing of the injector 26 are controlled by control signals from the ECU 2 (see FIG. 3).

The intake passage 21 is provided with a throttle valve 27. A TH actuator 27a formed e.g. by a DC motor is connected to the throttle valve 27. The TH actuator 27a is controlled by a control signal from the ECU 2 (see FIG. 3). This changes the opening of the throttle valve 27 (hereinafter referred to as the “throttle valve opening”), whereby the amount of air drawn into the cylinder C is adjusted.

Further, the engine 3 is provided with an evaporated fuel processor 31. The evaporated fuel processor 31 processes evaporated fuel generated in a fuel tank FT that stores fuel to be supplied to the engine 3, by trapping the evaporated fuel and supplying the same to the intake passage 21, as required, and includes a charge passage 32, a canister 33, and a purge passage 34.

The charge passage 32 is connected to the fuel tank FT and the canister 33,for sending evaporated fuel generated in the fuel tank FT to the canister 33. The charge passage 32 is provided with a two-way valve 35. The two-way valve 35 is formed by a mechanical valve as a combination of a positive pressure valve and a negative pressure valve each of a diaphragm type. The positive pressure valve is configured to be opened when pressure in the charge passage 32, which corresponds to pressure in the fuel tank FT, reaches upper limit pressure, i.e. predetermined pressure higher than the atmospheric pressure. The opening of the positive pressure valve causes the evaporated fuel in the fuel tank FT to be sent to the canister 33. Further, the above-mentioned negative pressure valve is configured to be opened when the pressure in the charge passage 32 reaches lower limit pressure, i.e. predetermined pressure lower than pressure in the canister 33. The opening of the negative pressure valve causes evaporated fuel having been adsorbed in the canister 33 to be returned to the fuel tank FT.

Further, the charge passage 32 is provided with a charge bypass passage 36 bypassing the two-way valve 35. The charge bypass passage 36 is provided with a bypass valve 41. The bypass valve 41 is formed by a normally-closed type electromagnetic ON/OFF valve. Normally, the bypass valve 41 closes the charge bypass passage 36, but when energized under the control of the ECU 2 (see FIG. 3), the bypass valve 41 opens to thereby open the charge bypass passage 36.

Activated carbon for adsorbing evaporated fuel is incorporated in the canister 33. Further, an atmospheric passage 37 open to the atmosphere is connected to the canister 33. The atmospheric passage 37 is provided with a vent shut valve 42 for opening and closing the same. The vent shut valve 42 is formed by a normally-open type electromagnetic ON/OFF valve. Normally, the vent shut valve 42 opens the atmospheric passage 37, but when energized under the control of the ECU 2 (see FIG. 3), the vent shut valve 42 closes the atmospheric passage 37.

The purge passage 34 is for supplying (purging) evaporated fuel absorbed by the canister 33 to the intake passage 21, and is connected to the canister 33 and a portion of the intake passage 21 downstream of the throttle valve 27. A purge control valve 43 is provided at an intermediate portion of the purge passage 34. The purge control valve 43 is formed by an electromagnetic valve, and the opening thereof is controlled by a control signal from the ECU 2 (see FIG. 3).

Further, an air flow sensor 63 and an intake air temperature sensor 64 are provided in the intake passage 21 at respective locations upstream of the throttle valve 27. The air flow sensor 63 detects the amount of air drawn into the engine 3 (hereinafter referred to as the “intake air amount”) GAIR, and delivers a detection signal indicative of the detected intake air amount GAIR to the ECU 2 (see FIG. 3). The intake air temperature sensor 64 detects a temperature of intake air in the intake passage (hereinafter referred to as the “intake air temperature”) TA, and delivers a detection signal indicative of the detected intake air temperature TA to the ECU 2.

The engine 3 is further provided with an EGR device 51. The EGR device 51 recirculates part of exhaust gases discharged into the exhaust passage 22 to the intake passage 21, and includes an EGR passage 52 connected to a portion of the intake passage 21 downstream of the throttle valve 27, and an EGR control valve 53 for opening and closing the EGR passage 52.

The EGR control valve 53 is formed by an electromagnetic valve the opening of which is continuously changed. The opening of the EGR control valve 53 is controlled by a control signal from the ECU 2 (see FIG. 3), whereby the amount of recirculated exhaust gases (hereinafter referred to as the “EGR gas amount”) is changed. Further, the opening of the EGR control valve 53 (hereinafter referred to as the “EGR control valve opening OEV”) is detected by an EGR valve opening sensor 65, and a detection signal indicative of the detected EGR control valve opening OEV is delivered to the ECU 2.

Further, a LAF sensor 66 is provided in a portion of the exhaust passage 22 downstream of a collector of an exhaust manifold. The LAF sensor 66 linearly detects a concentration of oxygen in exhaust gases flowing through the exhaust passage 22, in a broad air-fuel ratio range from a rich region richer than a stoichiometric air-fuel ratio to a very lean region, to deliver a detection signal indicative of the detected oxygen concentration to the ECU 2 (see FIG. 3), The ECU 2 calculates an equivalent ratio of the air-fuel ratio of a mixture burned in the engine 3 as a detected equivalent ratio KACT, based on the detection signal from the LAF sensor 66.

A three-way catalyst 28 and a binary type O2 sensor 67 are provided in respective portions of the exhaust passage 22 downstream of the LAF sensor 66. The three-way catalyst 28 purifies harmful components, such as HC, CO, and NOx, of exhaust gases. Further, the O2 sensor 67 has a characteristic that an output thereof drastically changes when the air-fuel ratio of the exhaust gases changes across the stoichiometric air-fuel ratio, and a detection signal SVO2 output therefrom goes high when the air-fuel ratio is richer than the stoichiometric air-fuel ratio and goes low when the air-fuel ratio is leaner than the stoichiometric air-fuel ratio. The detection signal SVO2 from the O2 sensor 67 is delivered to the ECU 2 (see FIG. 3). Furthermore, to the ECU 2, a detection signal indicative of an operation amount of an accelerator pedal (not shown) of the vehicle V (hereinafter referred to as the “accelerator pedal opening”) AP is delivered from an accelerator pedal opening sensor 68, and a detection signal indicative of a vehicle speed VP of the vehicle V is delivered from a vehicle speed sensor 69.

The ECU 2 is implemented by a microcomputer comprised of a CPU, a RAM, a ROM, and an I/O interface (none of which are shown). The ECU 2 controls operations of the engine 3, the evaporated fuel processor 31, and the EGR device 51, based on the detection signals from the aforementioned sensors 61 to 69, according to control programs stored in the ROM, and determines variation in air-fuel ratio between the four cylinders C (hereinafter referred to as the “AF variation”), a failure of the LAF sensor 66, a failure of the EGR device 51, and deterioration of the three-way catalyst 28.

Next, a description will be given of the outline of the determination of the AF variation, the failure of the LAF sensor 66, the failure of the EGR device 51, and the deterioration of the three-way catalyst 28.

The AF variation, the failure of the LAF sensor 66, the failure of the EGR device 51, and the deterioration of the three-way catalyst 28 are determined based on determining parameters obtained when the engine 3 is being controlled to respective specific operating states by control operations intended for determination, which are configured on a determination-by-determination basis. Therefore, determination operations for determining the AF variation, the failure of the LAF sensor 66, the failure of the EGR device 51, and the deterioration of the three-way catalyst 28 (FIGS. 7, 9, 11 and 15, referred to hereinafter) are sequentially performed without being performed in parallel with each other. Hereinafter, the determination operations for determining the AF variation, the failure of the LAF sensor 66, the failure of the EGR device 51, and the deterioration of the three-way catalyst 28 are referred to the “AF variation determination operation”, the “sensor failure determination operation”, the “EGR failure determination operation”, and the “catalyst deterioration determination operation”, respectively.

Further, these AF variation determination operation, sensor failure determination operation, EGR failure determination operation, and catalyst deterioration determination operation (FIGS. 5, 8, 10 and 13, referred to hereinafter) are each executed when an execution condition, set on a determination-by-determination basis, is satisfied, and are basically started in the order of satisfaction of the execution conditions. Each execution condition includes a condition concerning an operating state of the engine 3. Furthermore, the AF variation determination operation, the sensor failure determination operation, and the EGR failure determination operation are executed, on condition that the supply of evaporated fuel is stopped by the evaporated fuel processor 31 (hereinafter referred to as the “purge cut”), in a purge cut state. On the other hand, the catalyst deterioration determination operation is executed without using (requiring) the purge cut as the condition. Hereinafter, the AF variation determination operation, the sensor failure determination operation, and the EGR failure determination operation are collectively referred to as the “three determination operations involving the purge cut”, as deemed appropriate.

Therefore, to cause the three determination operations involving the purge cut to be sequentially and continuously executed so as to prevent the execution and non-execution of the purge cut from being repeated, in spite of the execution condition for the catalyst deterioration determination operation being satisfied during execution of first and second determination operations of the three determination operations, if the execution condition for the other determination operation of the three determination operations involving the purge cut is satisfied, the catalyst deterioration determination operation is inhibited from being executed following the completion of the determination operation in execution (FIGS. 13 and 14, referred to hereinafter).

Further, in a case where the three determination operations involving the purge cut are sequentially and continuously executed, the execution order thereof inevitably becomes one of the following orders A, B, C, and D due to the relationship between the determination operations and the execution conditions therefor. Furthermore, to make the three determination operations involving the purge cut properly continuous in the order B, the AF variation determination operation is inhibited, as required (FIGS. 5 and 6, referred to hereinafter). Further, during execution of each of the three determination operations involving the purge cut, an operating point of the engine 3 is controlled such that not only the execution condition for the determination operation in execution but also the execution condition for a determination operation to be executed next is satisfied (FIG. 12, referred to hereinafter).

A: AF variation determination operation→sensor failure determination operation→EGR failure determination operation

B: sensor failure determination operation→EGR failure determination operation→AF variation determination operation

C: EGR failure determination operation→sensor failure determination operation→AF variation determination operation

D: EGR failure determination operation→AF variation determination operation→sensor failure determination operation

Hereinafter, a process for determining the AF variation, the failure of the LAF sensor 66, the failure of the EGR device 51, and the deterioration of the three-way catalyst 28, according to the first embodiment, will be described with reference to FIG. 4. The present process is repeatedly performed at a predetermined repetition period.

First, in a step 1 (shown as S1; similar in the following), an AF variation-determining condition determination process is performed, and then an AF variation determination process is performed (step 2). Next, a sensor failure-determining condition determination process is performed (step 3), and a sensor failure determination process is performed (step 4). Then, an EGR failure-determining condition determination process is performed (step 5), and an EGR failure determination process is performed (step 6). Next, a catalyst deterioration-determining condition determination process is performed (step 7), and a catalyst deterioration determination process is performed (step 8), followed by terminating the present process.

FIG. 5 shows the AF variation-determining condition determination process performed in the step 1 in FIG. 4. The present process determines whether or not the execution condition for the AF variation determination operation (hereinafter referred to as the “AF variation determination execution condition) is satisfied. Note that each flag used in the present process and various processes, described hereinafter, is reset to 0 at the start of the system (the ECU2, etc.) or at the stop of the engine 3. For example, various determination execution condition satisfaction flags, including an AF variation determination execution condition satisfaction flag F_MCNDDIS, described hereinafter, are reset to 0 at the start of the system, and flags for determining operating conditions of the engine 3 are reset to 0 at the start of the system, and thereafter reset to 0 at the stop of the engine 3.

First, in a step 11, it is determined whether or not an AF variation determination execution condition is satisfied. The AF variation determination execution condition is determined to be satisfied when a plurality of predetermined conditions, including the following conditions a1 to e1, for example, are all satisfied. Note that any other suitable condition may be further included in the AF variation determination execution condition.

a1: The operating point of the engine 3, indicated by the engine speed NE and the intake air amount GAIR, is in a region α in an operating point determination map shown in FIG. 16.

b1: The LAF sensor 66 is activated.

c1: The engine coolant temperature TW is higher than a predetermined temperature.

d1: The amount of change in the engine speed NE is smaller than a predetermined value.

e1: The detected equivalent ratio KACT is within a predetermined range.

If the answer to the question of the step 11 is negative (NO), i.e. if the AF variation determination execution condition is not satisfied, to indicate the fact, the AF variation determination execution condition satisfaction flag F_MCNDDIS is set to 0 (step 12). Then, a continuous execution permission flag F_PERDIS for the AF variation determination operation is set to 0 (step 13), and a timer value tDIS1 of a first wait timer of a down-count type is set to a predetermined stabilization time TMSTE (step 14).

Next, it is determined in steps 15 and 16 whether or not a sensor failure determination execution condition satisfaction flag F_MCNDLAF and an EGR failure determination execution condition satisfaction flag F_MCNDEGR are equal to 1, respectively. The flags F_MCNDLAF and F_MCNDEGR indicate that the execution condition for the sensor failure determination operation (hereinafter referred to as the “sensor failure determination execution condition”), and the execution condition for the EGR failure determination operation (hereinafter referred to as the “EGR failure determination execution condition”) are satisfied, by 1, respectively.

If the answers to the questions of the steps 15 and 16 are both negative (NO) (F_MCNDLAF=0 and at the same time F_MCNDEGR=0), i.e. if none of the AF variation determination execution condition, the sensor failure determination execution condition, and the EGR failure determination execution condition are satisfied, a purge cut flag F_PURCUT is set to 0 (step 17), and the process proceeds to a step 18. The purge cut flag F_PURCUT indicates that the purge cut is being executed, by 1.

On the other hand, if one of the answers to the questions of the steps 15 and 16 is affirmative (YES), i.e. if one of the sensor failure determination execution condition and the EGR failure determination execution condition is satisfied, the step 17 is skipped, and the process proceeds to the step 18.

In the step 18, an AF variation determination in-operation flag F_MIDDIS is set to 0, followed by terminating the present process. The AF variation determination in-operation flag F_MIDDIS indicates that the AF variation determination operation is being executed, by 1.

On the other hand, if the answer to the question of the step 11 is affirmative (YES), i.e. if the AF variation determination execution condition is satisfied, it is determined whether or not the AF variation determination in-operation flag F_MIDDIS is equal to 1 (step 19). If the answer to this question is negative (NO) (F_MIDDIS=0), to indicate that the AF variation determination execution condition is satisfied, the AF variation determination execution condition satisfaction flag F_MCNDDIS is set to 1 (step 20).

Then, it is determined whether or not a first earliest satisfaction flag F_THR1st is equal to 1 (step 21). The first earliest satisfaction flag F_THR1st indicates that the AF variation determination execution condition has been satisfied earlier than the sensor failure determination execution condition and the EGR failure determination execution condition, by 1, and is set based on the AF variation determination execution condition satisfaction flag F_MCNDDIS, the sensor failure determination execution condition satisfaction flag F_MCNDLAF, and the EGR failure determination execution condition satisfaction flag F_MCNDEGR.

Further, the first earliest satisfaction flag F_THR1st is reset to 0 when the AF variation determination operation is completed. Furthermore, even if the AF variation determination execution condition was satisfied first, the first earliest satisfaction flag F_THR1st is reset to 0, when the AF variation determination execution condition has ceased to be satisfied before completion of the AF variation determination operation, and the sensor failure determination execution condition or the EGR failure determination execution condition is satisfied.

If the answer to the question of the step 21 is affirmative (YES), a step 24, described hereinafter, is executed, whereas if the answer to the question of the step 21 is negative (NO) (F_THR1st=0), i.e. if the sensor failure determination execution condition and/or the EGR failure determination execution condition have/has been satisfied earlier than the AF variation determination execution condition, a first continuous execution permission process is performed (step 22).

FIG. 6 shows the first continuous execution permission process. The present process permits/inhibits the AF variation determination operation to be executed/from being executed following the completion of the sensor failure determination operation or the EGR failure determination operation. First, it is determined in a step 41 in FIG. 6 whether or not a sensor failure determination in-operation flag F_MIDLAF is equal to 1. The sensor failure determination in-operation flag F_MIDLAF indicates that the sensor failure determination operation is being executed, by 1.

If the answer to the question of the step 41 is negative (NO) (F_MIDLAF=0), it is determined whether or not an EGR failure determination in-operation flag F_MIDEGR is equal to 1 (step 42). The EGR failure determination in-operation flag F_MIDEGR indicates that the EGR failure determination operation is being executed, by 1.

If the answer to the question of the step 42 is negative (NO) (F_MIDEGR=0), it is determined whether or not a sensor failure determination operation completion flag F_DONLAF is equal to 1 (step 43). The sensor failure determination operation completion flag F_DONLAF indicates that the sensor failure determination operation has been completed, by 1.

If the answer to the question of the step 43 is negative (NO) (F_DONLAF=0), it is determined whether or not an EGR failure determination operation completion flag F_DONEGR is equal to 1 (step 44). The EGR failure determination operation completion flag F_DONEGR indicates that the EGR failure determination operation has been completed, by 1.

If the answer to the question of the step 44 is negative (NO) (F_DONEGR=0), i.e. if the sensor failure determination operation and the EGR failure determination operation have not been started, the continuous execution permission flag F_PERDIS is set to 1 (step 45), followed by terminating the present process.

On the other hand, if the answer to the question of the step 41 is affirmative (YES) (F_MIDLAF=1), i.e. if the sensor failure determination operation is being executed, it is determined whether or not a first determination in-operation flag F_MID1st is equal to 1 (step 46).

The first determination in-operation flag F_MID1st indicates that a determination operation which has been started first out of the three determination operations involving the purge cut is being executed, by 1, and is set based on the AF variation determination in-operation flag F_MIDDIS, the sensor failure determination in-operation flag F_MIDLAF, the EGR failure determination in-operation flag F_MIDEGR, an AF variation determination operation completion flag F_DONDIS, described hereinafter, the sensor failure determination operation completion flag F_DONLAF, and the EGR failure determination operation completion flag F_DONEGR.

Further, the first determination in-operation flag F_MID1st is reset to 0 when the first determination operation is completed. Furthermore, in a case where the first determination operation is suspended without being completed, the first determination in-operation flag F_MID1st is once reset to 0, and is set to 1 when the first determination operation is resumed. The first determination in-operation flag F_MID1st is set to 1 also when the first determination operation has been suspended without being completed, and a determination operation different from the suspended determination operation is started.

If the answer to the question of the step 46 is affirmative (YES) (F_MID1st=1), i.e. if the sensor failure determination operation is executed as a first determination operation of the three determination operations involving the purge cut, and the determination operation is being executed, it is determined whether or not the EGR failure determination execution condition satisfaction flag F_MCNDEGR is equal to 1 (step 47). If the answer to this question is negative (NO) (F_MCNDEGR=0), i.e. if the sensor failure determination operation as the first determination operation is being executed, and at the same time the EGR failure determination execution condition is not satisfied, the step 45 is executed in order to permit the AF variation determination operation to be executed continuously from the completion of the sensor failure determination operation, followed by terminating the present process.

On the other hand, if the answer to the question of the step 47 is affirmative (YES) (F_MCNDEGR=1), i.e. if the sensor failure determination operation as the first determination operation is being executed, and at the same time the EGR failure determination execution condition is satisfied, the continuous execution permission flag F_PERDIS is set to 0 (step 48) in order to inhibit the AF variation determination operation from being executed continuously from the completion of the sensor failure determination operation, followed by terminating the present process.

On the other hand, if the answer to the question of the step 46 is negative (NO) (F_MID1st=0), i.e. if the sensor failure determination operation is executed as a second determination operation of the three determination operations involving the purge cut, and the determination operation is being executed, the present process is immediately terminated.

As described above, when the sensor failure determination operation is being executed, and at the same time the first determination operation is not being executed (NO to the step 46), it is regarded that the sensor failure determination operation as the second determination operation is being executed, because the AF variation-determining condition determination process including the present process is not performed until a predetermine time period elapses after the completion of the AF variation determination operation.

On the other hand, if the answer to the question of the step 42 is affirmative (YES) (F_MID1st=1), i.e. if the EGR failure determination operation is being executed, it is determined whether or not the first determination in-operation flag F_MID1st is equal to 1 (step 49). If the answer to this question is affirmative (YES) (F_MID1st=1), i.e. if the EGR failure determination operation is executed as a first determination operation of the three determination operations involving the purge cut, and the determination operation is being executed, it is determined whether or not an earlier satisfaction flag F_BEFLAF is equal to 1 (step 50).

The earlier satisfaction flag F_BEFLAF indicates that the sensor failure determination execution condition has been satisfied earlier than the AF variation determination execution condition during execution of the EGR failure determination operation as the first determination operation, by 1, and is set based on the sensor failure determination execution condition satisfaction flag F_MCNDLAF and the AF variation determination execution condition satisfaction flag F_MCNDDIS. Note that the earlier satisfaction flag F_BEFLAF is reset to 0 even if the sensor failure determination execution condition was once satisfied earlier than the AF variation determination execution condition, when the sensor failure determination execution condition has ceased to be satisfied before the start of the sensor failure determination operation. Further, the earlier satisfaction flag F_BEFLAF is reset to 0 when all the three determination operations involving the purge cut have been completed.

If the answer to the question of the step 50 is negative (NO) (F_BEFLAF=0), i.e. if the EGR failure determination operation as the first determination operation is being executed, and at the same time the sensor failure determination execution condition has not been satisfied earlier than the AF variation determination execution condition, the step 45 is executed in order to permit the AF variation determination operation to be executed continuously from the completion of the EGR failure determination operation, followed by terminating the present process.

On the other hand, if the answer to the question of the step 50 is affirmative (YES) (F_BEFLAF=1), i.e. if the EGR failure determination operation as the first determination operation is being executed, and at the same time the sensor failure determination execution condition has been satisfied earlier than the AF variation determination execution condition, the step 48 is executed in order to inhibit the AF variation determination operation from being executed following the completion of the EGR failure determination operation, followed by terminating the present process.

On the other hand, if the answer to the question of the step 49 is negative (NO) (F_MID1st=0), i.e. if the EGR failure determination operation is executed as a second determination operation of the three determination operations involving the purge cut, and the determination operation is being executed, the step 48 is executed, followed by terminating the present process.

As described above, when the determination operation in execution is not the first determination operation of the three determination operations involving the purge cut (NO to the step 49), the determination operation in execution is regarded as the second determination operation for the same reason as given in the step 46.

On the other hand, if the answer to the question of the step 44 is affirmative (YES) (F_DONEGR=1), i.e. if the EGR failure determination operation has been completed as the first determination operation of the three determination operations involving the purge cut, and the sensor failure determination operation is not being executed or has not been completed, the step 50 et seq. are executed, followed by terminating the present process.

On the other hand, if the answer to the question of the step 43 is affirmative (YES) (F_DONLAF=1), i.e. if the sensor failure determination operation has been completed, it is determined whether or not the EGR failure determination operation completion flag F_DONEGR is equal to 1 (step 51). If the answer to this question is negative (NO) (F_DONEGR=0), i.e. if the sensor failure determination operation has been completed, and the EGR failure determination operation has not been completed, the present process is immediately terminated.

On the other hand, if the answer to the question of the step 51 is affirmative (YES) (F_DONEGR=1), i.e. if both the sensor failure determination operation and the EGR failure determination operation have been completed, the step 45 is executed in order to permit the AF variation determination operation to be executed continuously from the completion of the sensor failure determination operation or the EGR failure determination operation, followed by terminating the present process.

Referring again to FIG. 5, in a step 23 following the step 22, it is determined whether or not the continuous execution permission flag F_PERDIS set in the step 45 or 48 in FIG. 6 is equal to 1. If the answer to this question is negative (NO) (F_PERDIS=0), i.e. if the AF variation determination operation is inhibited from being executed following the completion of the sensor failure determination operation or the EGR failure determination operation, the step 18 is executed, followed by terminating the present process.

On the other hand, if the answer to the question of the step 23 is affirmative (YES) (F_PERDIS=1), i.e. if the AF variation determination operation is permitted to be executed following the completion of the sensor failure determination operation or the EGR failure determination operation, it is determined whether or not a catalyst deterioration determination in-operation flag F_MIDCAT is equal to 1 (step 24). The catalyst deterioration determination in-operation flag F_MIDCAT indicates that the catalyst deterioration determination operation is being executed, by 1.

If the answer to the question of the step 24 is affirmative (YES) (F_MIDCAT=1), i.e. if the catalyst deterioration determination operation is being executed, to hold the AF variation determination operation, the step 18 is executed (F_MIDDIS←0), followed by terminating the present process. On the other hand, if the answer to the question of the step 24 is negative (NO), it is determined whether or not the timer value tDIS1 of the first wait timer set in the step 14 is equal to 0 (step 25).

If the answer to the question of the step 25 is negative (NO), to hold the AF variation determination operation, the step 18 is executed (F_MIDDIS←0), followed by terminating the present process.

On the other hand, if the answer to the question of the step 25 is affirmative (YES) (tDIS1=0), i.e. if the stabilization time TMSTE has elapsed after satisfaction of the AF variation determination execution condition, it is determined whether or not the purge cut flag F_PURCUT is equal to 1 (step 26). If the answer to this question is negative (NO) (F_PURCUT=0), i.e. if the purge cut is not being executed, to execute the purge cut, the purge cut flag F_PURCUT is set to 1 (step 27), and a timer value tDIS2 of a second wait timer of the down-count type is set to a predetermined initial wait time TMDINT (step 28).

On the other hand, if the answer to the question of the step 26 is affirmative (YES), i.e. if the purge cut is being executed, the timer value tDIS2 of the second wait timer is set to a predetermined reduced wait time TMDDEC (step 29). The reduced wait time TMDDEC is set to a time period shorter than the above-mentioned initial wait time TMDINT.

In steps 30 and 31 following the step 28 or 29, it is determined whether or not the sensor failure determination in-operation flag F_MIDLAF and the EGR failure determination in-operation flag F_MIDEGR are equal to 1, respectively. If one of the answers to the questions of the steps 30 and 31 is affirmative (YES) (F_MIDLAF=1 or F_MIDEGR=1), i.e. if one of the sensor failure determination operation and the EGR failure determination operation is being executed, to hold the AF variation determination operation, the step 18 is executed, followed by terminating the present process.

On the other hand, if the answers to the questions of the steps 30 and 31 are both negative (NO) (F_MIDLAF=0 and at the same time F_MIDEGR=0), i.e. if neither of the sensor failure determination operation and the EGR failure determination operation is being executed, to start the AF variation determination operation, the AF variation determination in-operation flag F_MIDDIS is set to 1 (step 32), followed by terminating the present process. By executing the step 32, the answer to the question of the step 19 becomes affirmative (YES) (F_MIDDIS=1), and in this case, the present process is immediately terminated.

Further, FIG. 7 shows the AF variation determination process performed in the step 2 in FIG. 4. The present process is for executing the AF variation determination operation. In the present process, an AF variation is determined by the same method as proposed by the present applicant in Japanese Patent No. 5335704, and hence, hereafter, a brief description will be given of the present process.

First, in a step 61 in FIG. 7, it is determined whether or not the AF variation determination in-operation flag F_MIDDIS set in the step 18 or 32 in FIG. 5 is equal to 1. If the answer to the question of the step 61 is negative (NO) (F_MIDDIS=0), an EGR cut flag F_EGRCUT, referred to hereinafter, is set to 0 (step 62), followed by terminating the present process.

On the other hand, if the answer to the question of the step 61 is affirmative (YES) (F_MIDDIS=1), the AF variation determination operation is executed in the next step 63 et seq. First, in the step 63, the purge cut flag F_PURCUT is set to 1, and purge cut (stopping of supply of evaporated fuel) is performed. Then, air-fuel ratio control intended for determination is performed (step 64). In the air-fuel ratio control intended for determination, a target equivalent ratio is set such that the target equivalent ratio is changed at a predetermined control period, and the fuel injection amount is controlled such that the detected equivalent ratio KACT becomes equal to the set target equivalent ratio.

Next, the EGR cut flag F_EGRCUT is set to 1 (step 65). With this, EGR stop control is performed, whereby the EGR control valve 53 is controlled to a fully-closed state to stop the recirculation of exhaust gases by the EGR device 51. Then, it is determined whether or not a periodical change flag F_VARCYC is equal to 1 (step 66). The periodical change flag F_VARCYC indicates that the target equivalent ratio is changed at the control period by execution of the air-fuel ratio control intended for determination in the step 64, by 1. If the answer to the question of the step 66 is negative (NO) (F_VARCYC=0), the present process is immediately terminated.

On the other hand, if the answer to the question of the step 66 is affirmative (YES) (F_VARCYC=1), i.e. if the target equivalent ratio is changed at the control period, a first filtered equivalent ratio KACTF1 is calculated by filtering the detected equivalent ratio KACT with a predetermined first band pass filter (step 67). The first band pass filter is configured to extract a frequency component of a 0.5-th order of the engine speed NE, from the detected equivalent ratio KACT. For a filtering equation therefor, refer to Japanese Patent No. 5335704.

In a step 68 following the step 67, a current first integral value SUMKF1 is calculated by adding the calculated first filtered equivalent ratio KACTF1 to the immediately preceding value of the first integral value SUMKF1. Note that at the time of the first execution of the present process, the immediately preceding value of the first integral value SUMKF1 is set to 0.

Then, a second filtered equivalent ratio KACTF2 is calculated by filtering the detected equivalent ratio KACT with a predetermined second band pass filter (step 69). The second band pass filter is configured to extract a frequency component corresponding to the above-mentioned control period, from the detected equivalent ratio KACT. For a filtering equation therefor, refer to Japanese Patent No. 5335704.

In a step 70 following the step 69, a current second integral value SUMKF2 is calculated by adding the calculated second filtered equivalent ratio KACTF2 to the immediately preceding value of the second integral value SUMKF2. Note that at the time of the first execution of the present process, the immediately preceding value of the second integral value SUMKF2 is set to 0.

Then, it is determined whether or not the timer value tDIS2 of the second wait timer set in the step 28 or 29 in FIG. 5 is equal to 0 (step 71). If the answer to this question is negative (NO), the present process is immediately terminated, whereas if the answer to the question of the step 71 is affirmative (YES) (tDIS2=0), i.e. if the initial wait time TMDINT or the reduced wait time TMDDEC has elapsed after the start of the execution of the AF variation determination operation, an AF variation-determining parameter JUDDIS is calculated by dividing the first integral value SUMKF1 calculated in the step 68 by the second integral value SUMKF2 calculated in the step 70 (step 72).

Then, it is determined whether or not the calculated AF variation-determining parameter JUDDIS is larger than a predetermined threshold value DISREF (step 73). If the answer to this question is affirmative (YES) (JUDDIS>DISREF), it is determined that an AF variation has occurred, and to indicate the fact, an AF variation flag F_DISPNG is set to 1 (step 74). On the other hand, if the answer to the question of the step 73 is negative (NO), it is determined that no AF variation has occurred, and to indicate the fact, the AF variation flag F_DISPNG is set to 0 (step 75).

In a step 76 following the step 74 or 75, to indicate that the AF variation determination operation has been completed, the AF variation determination operation completion flag F_DONDIS is set to 1. Then, the various flags related to the AF variation determination operation are reset (step 77), followed by terminating the present process. That is, the AF variation determination execution condition satisfaction flag F_MCNDDIS, the continuous execution permission flag F_PERDIS, and the AF variation determination in-operation flag F_MIDDIS are all reset to 0.

Note that in the case where the AF variation determination operation has been completed as described above, when any of the other three determination operations (the sensor failure determination operation, the EGR failure determination operation, and the catalyst deterioration determination operation) has not been completed, the execution of the processes shown in FIGS. 5 to 7 is stopped until all the other three determination operations are completed (the steps 1 and 2 in FIG. 4 are skipped). Further, when the four determination operations including the AF variation determination operation are completed, the AF variation determination operation completion flag F_DONDIS is reset to 0, and the execution of the processes shown in FIGS. 5 to 7 is resumed.

Next, the sensor failure-determining condition determination process performed in the step 3 in FIG. 4 will be described with reference to FIG. 8. The present process determines whether or not the sensor failure determination execution condition (the execution condition for the sensor failure determination operation) is satisfied.

First, in a step 81 in FIG. 8, it is determined whether or not the sensor failure determination execution condition is satisfied. The sensor failure determination execution condition is determined to be satisfied when a plurality of predetermined conditions, including the following conditions a2 to c2, for example, are all satisfied. Note that any other suitable condition may be further included in the sensor failure determination execution condition.

a2: The operating point of the engine 3, indicated by the engine speed NE and the intake air amount GAIR, is in a region β in the operating point determination map shown in FIG. 16.

b2: The LAF sensor 66 is activated.

c2: The detected vehicle speed VP is within a predetermined range.

If the answer to the question of the step 81 is negative (NO), i.e. if the sensor failure determination execution condition is not satisfied, to indicate the fact, the sensor failure determination execution condition satisfaction flag F_MCNDLAF is set to 0 (step 82), and a timer value tLAF1 of the first wait timer of the down-count type is set to the stabilization time TMSTE (step 83).

Next, it is determined in steps 84 and 85 whether or not the AF variation determination execution condition satisfaction flag F_MCNDDIS and the EGR failure determination execution condition satisfaction flag F_MCNDEGR are equal to 1, respectively. If the answers to the questions of the steps 84 and 85 are both negative (NO) (F_MCNDDIS=0 and at the same time F_MCNDEGR=0), i.e. if none of the sensor failure determination execution condition, the AF variation determination execution condition, and the EGR failure determination execution condition are satisfied, the purge cut flag F_PURCUT is set to 0 (step 86), and the process proceeds to a step 87.

On the other hand, if one of the answers to the questions of the steps 84 and 85 is affirmative (YES), i.e. if one of the AF variation determination execution condition and the EGR failure determination execution condition is satisfied, the step 86 is skipped, and the process proceeds to the step 87.

In the step 87, the sensor failure determination in-operation flag F_MIDLAF is set to 0, followed by terminating the present process. The sensor failure determination in-operation flag F_MIDLAF indicates that the sensor failure determination operation is being executed, by 1.

On the other hand, if the answer to the question of the step 81 is affirmative (YES), i.e. if the sensor failure determination execution condition is satisfied, it is determined whether or not the sensor failure determination in-operation flag F_MIDLAF is equal to 1 (step 88). If the answer to this question is negative (NO) (F_MIDLAF=0), to indicate that the sensor failure determination execution condition is satisfied, the sensor failure determination execution condition satisfaction flag F_MCNDLAF is set to 1 (step 89).

Then, it is determined whether or not the catalyst deterioration determination in-operation flag F_MIDCAT is equal to 1 (step 90). If the answer to this question is affirmative (YES) (F_MIDCAT=1), i.e. if the catalyst deterioration determination operation is being executed, to hold the sensor failure determination operation, the step 87 is executed, followed by terminating the present process.

On the other hand, if the answer to the question of the step 90 is negative (NO) (F_MIDCAT=0), it is determined whether or not the timer value tLAF1 of the first wait timer set in the step 83 is equal to 0 (step 91). If the answer to this question is negative (NO), to hold the sensor failure determination operation, the step 87 is executed (F_MIDLAF←0), followed by terminating the present process.

On the other hand, if the answer to the question of the step 91 is affirmative (YES) (tLAF1=0), i.e. if the stabilization time TMSTE has elapsed after satisfaction of the sensor failure determination execution condition, it is determined whether or not the purge cut flag F_PURCUT is equal to 1 (step 92). If the answer to this question is negative (NO) (F_PURCUT=0), i.e. if the purge cut is not being executed, to execute the purge cut, the purge cut flag F_PURCUT is set to 1 (step 93), and a timer value tLAF2 of the second wait timer of the down-count type is set to a predetermined initial wait time TMLINT (step 94).

On the other hand, if the answer to the question of the step 92 is affirmative (YES), i.e. if the purge cut is being executed, the timer value tLAF2 of the second wait timer is set to a predetermined reduced wait time TMLDEC (step 95). The reduced wait time TMLDEC is set to a time period shorter than the above-mentioned initial wait time TMLINT.

In steps 96 and 97 following the step 94 or 95, it is determined whether or not the AF variation determination in-operation flag F_MIDDIS and the EGR failure determination in-operation flag F_MIDEGR are equal to 1, respectively. If one of the answers to the questions of the steps 96 and 97 is affirmative (YES), i.e. if one of the AF variation determination operation and the EGR failure determination operation is being executed, to hold the sensor failure determination operation, the step 87 is executed, followed by terminating the present process.

On the other hand, if the answers to the questions of the steps 96 and 97 are both negative (NO), i.e. if neither of the AF variation determination operation and the EGR failure determination operation is being executed, to start the sensor failure determination operation, the sensor failure determination in-operation flag F_MIDLAF is set to 1 (step 98), followed by terminating the present process. By executing the step 98, the answer to the question of the step 88 becomes affirmative (YES) (F_MIDLAF=1), and in this case, the present process is immediately terminated.

Further, FIG. 9 shows the sensor failure determination process performed in the step 4 in FIG. 4. The present process is for executing the sensor failure determination operation. In the present process, the failure of the LAF sensor 66 is determined by the same method proposed by the present applicant in Japanese Patent No. 4459566, and hence, hereafter, a brief description will be given of the present process.

First, in a step 101 in FIG. 9, it is determined whether or not the sensor failure determination in-operation flag F_MIDLAF set in the step 87 or 98 in FIG. 8 is equal to 1. If the answer to this question is negative (NO) (F_MIDLAF=0), a timer value tLAFDET of an integration timer of a down-count type is set to a predetermined time period TLREF (step 102), followed by terminating the present process.

On the other hand, if the answer to the question of the step 101 is affirmative (YES) (F_MIDLAF=1), the sensor failure determination operation is executed in the next step 103 et seq. First, in the step 103, the purge cut flag F_PURCUT is set to 1, and purge cut is executed. Then, injection control intended for determination is performed (step 104).

In the injection control intended for determination, a correction term KIDSIN is calculated by adding a predetermined offset amount to a sine wave with a predetermined frequency and an amplitude, and a fuel injection amount INJ is calculated by multiplying a basic fuel injection amount by the calculated correction term KIDSIN. Then, a fuel injection amount from the injector 26 is controlled by inputting a control signal based on the calculated fuel injection amount INJ to the injector 26. The basic fuel injection amount is calculated by searching a predetermined map based on the intake air amount GAIR.

Note that during execution of the sensor failure determination operation, the EGR control valve opening OEV is controlled according to an operating state of the engine 3, such as the engine speed NE, differently from the case of the AF variation determination operation.

In a step 105 following the step 104, a filtered equivalent ratio KACTF is calculated by filtering the detected equivalent ratio KACT with a predetermined band pass filter. The band pass filter is configured to extract a frequency component as high as the frequency of the above-mentioned sine wave, from the detected equivalent ratio KACT. For a filtering equation therefor, refer to Japanese Patent No. 4459566.

In a step 106 following the step 105, an absolute value KACTFA of the filtered equivalent ratio KACTF is calculated. Then, it is determined whether or not the timer value tLAF2 of the second wait timer, set in the step 94 or 95 in FIG. 8, is equal to 0 (step 107). If the answer to this question is negative (NO), the step 102 is executed, followed by terminating the present process.

On the other hand, if the answer to the question of the step 107 is affirmative (YES) (tLAF2=0), i.e. if the initial wait time TMLINT or the reduced wait time TMLDEC has elapsed after the start of the execution of the sensor failure determination operation, a current integral value LAFDLYP is calculated by adding the absolute value KACTFA calculated in the step 106 to the immediately preceding value of the integral value LAFDLYP (step 108). Note that at the time of the first execution of the present process, the immediately preceding value of the integral value LAFDLYP is set to 0.

Then, it is determined whether or not the timer value tLAFDET of the integration timer, set in the step 102, is equal to 0 (step 109). If the answer to this question is negative (NO), the present process is immediately terminated, whereas if the answer to the question of the step 109 is affirmative (YES) (tLAFDET=0), i.e. if the calculation of the absolute value KACTFA in the step 108 has been repeatedly performed over the predetermined time period TLREF, it is determined whether or not the integral value LAFDLYP is smaller than a reference value LAFDLYPOK (step 110).

If the answer to the question of the step 110 is affirmative (YES) (LAFDLYP<LAFDLYPOK), it is determined that the LAF sensor 66 is faulty, and to indicate the fact, a sensor failure flag F_LAFSNG is set to 1 (step 111). On the other hand, if the answer to the question of the step 110 is negative (NO) (LAFDLYP≧LAFDLYPOK), it is determined that the LAF sensor 66 is not faulty, and to indicate the fact, the sensor failure flag F_LAFSNG is set to 0 (step 112).

In a step 113 following the step 111 or 112, to indicate that the sensor failure determination operation has been completed, the sensor failure determination operation completion flag F_DONLAF is set to 1. Then, the various flags related to the sensor failure determination operation are reset (step 114), followed by terminating the present process. That is, both the sensor failure determination execution condition satisfaction flag F_MCNDLAF and the sensor failure determination in-operation flag F_MIDLAF are reset to 0.

Note that in the case where the sensor failure determination operation has been completed as described above, when any of the other three determination operations (the AF variation determination operation, the EGR failure determination operation, and the catalyst deterioration determination operation) has not been completed, the execution of the processes shown in FIGS. 8 and 9 is stopped until all the other three determination operations are completed (the steps 3 and 4 in FIG. 4 are skipped). Further, when the four determination operations including the sensor failure determination operation are completed, the sensor failure determination operation completion flag F_DONLAF is reset to 0, and the execution of the processes shown in FIGS. 8 and 9 is resumed.

Next, the EGR failure-determining condition determination process performed in the step 5 in FIG. 4 will be described with reference to FIG. 10. The present process is for determining whether or not the EGR failure determination execution condition (the execution condition for the EGR failure determination operation) is satisfied.

First, in a step 121 in FIG. 10, it is determined whether or not the EGR failure determination execution condition is satisfied. The EGR failure determination execution condition is determined to be satisfied when a plurality of predetermined conditions, including the following conditions a3 to e3, for example, are all satisfied. Note that satisfaction of the condition b3 is determined based on the detected EGR control valve opening OEV. Further, any other suitable condition may be further included in the EGR failure determination execution condition.

a3: The operating point of the engine 3, indicated by the engine speed NE and the intake air amount GAIR, is in a region γ in the operating point determination map shown in FIG. 16.

b3: Exhaust gases were recirculated by the EGR device 51 before the start of the EGR failure determination operation (or, recirculation of exhaust gases can be executed).

c3: The detected intake air temperature TA is higher than a predetermined intake air temperature.

d3: The engine coolant temperature TW is higher than a predetermined engine coolant temperature.

e3: The vehicle speed VP is higher than a predetermined vehicle speed.

If the answer to the question of the step 121 is negative (NO), i.e. if the EGR failure determination execution condition is not satisfied, to indicate the fact, the EGR failure determination execution condition satisfaction flag F_MCNDEGR is set to 0 (step 122), and a timer value tEGR1 of the first wait timer of the down-count type is set to the stabilization time TMSTE (step 123).

Then, it is determined in steps 124 and 125 whether or not the AF variation determination execution condition satisfaction flag F_MCNDDIS and the sensor failure determination execution condition satisfaction flag F_MCNDLAF are equal to 1, respectively. If the answers to the questions of the steps 124 and 125 are both negative (NO) (F_MCNDDIS=0 and at the same time F_MCNDLAF=0), i.e. if none of the EGR failure determination execution condition, the AF variation determination execution condition, and the sensor failure determination execution condition are satisfied, the purge cut flag F_PURCUT is set to 0 (step 126), and the process proceeds to a step 127.

On the other hand, if one of the answers to the questions of the steps 124 and 125 is affirmative (YES), i.e. if one of the AF variation determination execution condition and the LAF determination execution condition is satisfied, the step 126 is skipped, and the process proceeds to the step 127.

In the step 127, the EGR failure determination in-operation flag F_MIDEGR is set to 0, followed by terminating the present process. The EGR failure determination in-operation flag F_MIDEGR indicates that the EGR failure determination operation is being executed, by 1.

On the other hand, if the answer to the question of the step 121 is affirmative (YES), i.e. if the EGR failure determination execution condition is satisfied, it is determined whether or not the EGR failure determination in-operation flag F_MIDEGR is equal to 1 (step 128). If the answer to this question is negative (NO) (F_MIDEGR=0), to indicate that the EGR failure determination execution condition is satisfied, the EGR failure determination execution condition satisfaction flag F_MCNDEGR is set to 1 (step 129).

Then, it is determined whether or not the catalyst deterioration determination in-operation flag F_MIDCAT is equal to 1 (step 130). If the answer to this question is affirmative (YES) (F_MIDCAT=1), i.e. if the catalyst deterioration determination operation is being executed, to hold the EGR failure determination operation, the step 127 is executed, followed by terminating the present process.

On the other hand, if the answer to the question of the step 130 is negative (NO) (F_MIDCAT=0), it is determined whether or not the timer value tEGR1 of the first wait timer set in the step 123 is equal to 0 (step 131). If the answer to this question is negative (NO), to hold the EGR failure determination operation, the step 127 is executed (F_MIDEGR←0), followed by terminating the present process.

On the other hand, if the answer to the question of the step 131 is affirmative (YES) (tEGR1=0), i.e. if the stabilization time TMSTE has elapsed after satisfaction of the EGR failure determination execution condition, it is determined whether or not the purge cut flag F_PURCUT is equal to 1 (step 132). If the answer to this question is negative (NO) (F_PURCUT=0), i.e. if the purge cut is not being executed, to execute the purge cut, the purge cut flag F_PURCUT is set to 1 (step 133), and a timer value tEGR2 of the second wait timer of the down-count type is set to a predetermined initial wait time TMEINT (step 134).

On the other hand, if the answer to the question of the step 132 is affirmative (YES), i.e. if the purge cut is being executed, the timer value tEGR2 of the second wait timer is set to a predetermined reduced wait time TMEDEC (step 135). The reduced wait time TMEDEC is set to a time period shorter than the above-mentioned initial wait time TMEINT. In a step 136 following the step 134 or 135, it is determined whether or not the sensor failure determination in-operation flag F_MIDLAF is equal to 1. If the answer to this question is affirmative (YES) (F_MIDLAF=1), i.e. if the sensor failure determination operation is being executed, to hold the EGR failure determination operation, the step 127 is executed, followed by terminating the present process.

On the other hand, if the answer to the question of the step 136 is negative (NO), i.e. if the sensor failure determination operation is not being executed, to start the EGR failure determination operation, the EGR failure determination in-operation flag F_MIDEGR is set to 1 (step 137), followed by terminating the present process. By executing the step 137, the answer to the question of the step 128 becomes affirmative (YES) (F_MIDEGR=1), and in this case, the present process is immediately terminated.

Further, FIG. 11 shows the EGR failure determination process performed in the step 6 in FIG. 4. The present process is for executing the EGR failure determination operation. In the present process, the failure of the EGR device 51 is determined by the same method as proposed by the present applicant in Japanese Patent No. 4531597, and hence, hereafter, a brief description will be given of the present process.

First, in a step 141 in FIG. 11, it is determined whether or not the EGR failure determination in-operation flag F_MIDEGR set in the step 127 or 137 in FIG. 10 is equal to 1. If the answer to this question is negative (NO) (F_MIDEGR=0), a timer value tEGRDET of the integration timer of the down-count type is set to a predetermined time period TEREF (step 142), followed by terminating the present process.

On the other hand, if the answer to the question of the step 141 is affirmative (YES) (F_MIDEGR=1), the EGR failure determination operation is executed in the next step 143 et seq. First, in the step 143, the purge cut flag F_PURCUT is set to 1, and purge cut is executed. Then, EGR control intended for determination is performed (step 144). In the EGR control intended for determination, the EGR control valve opening OEV is repeatedly controlled to open and close the EGR control valve 53 a plurality of times at a fixed repetition period.

Then, air-fuel ratio feedback control is performed (step 145). In the air-fuel ratio feedback control, an air-fuel ratio correction coefficient KAF is calculated using a predetermined feedback control algorism such that the detected equivalent ratio KACT becomes equal to a target equivalent ratio, and the fuel injection amount INJ is calculated by correcting the basic fuel injection amount using the calculated air-fuel ratio correction coefficient KAF. Then, a control signal based on the calculated fuel injection amount INJ is input to the injector 26, whereby the fuel injection amount from the injector 26 is controlled. The method of calculating the basic fuel injection amount is as described above.

In a step 146 following the step 145, a filtered correction coefficient KAFF is calculated by filtering the air-fuel ratio correction coefficient KAF with a predetermined band pass filter. For a filtering equation therefor, refer to Japanese Patent No. 4531597.

Then, an absolute value KAFFA of the filtered correction coefficient KAFF is calculated (step 147). Then, it is determined whether or not the timer value tEGR2 of the second wait timer, set in the step 134 or 135 in FIG. 10, is equal to 0 (step 148). If the answer to this question is negative (NO), the step 142 is executed, followed by terminating the present process.

On the other hand, if the answer to the question of the step 148 is affirmative (YES) (tEGR2=0), i.e. if the initial wait time TMLINT or the reduced wait time TMEDEC has elapsed after the start of the execution of the EGR failure determination operation, a current integral value RT80AX is calculated by adding the absolute value KAFFA calculated in the step 147 to the immediately preceding value of the integral value RT80AX (step 149). Note that at the time of the first execution of the present process, the immediately preceding value of the integral value RT80AX is set to 0.

Then, it is determined whether or not the timer value tEGRDET of the integration timer, set in the step 142, is equal to 0 (step 150). If the answer to this question is negative (NO), the present process is immediately terminated, whereas if the answer to the question of the step 150 is affirmative (YES) (tEGRDET=0), i.e. if the calculation of the absolute value KAFFA in the step 149 has been repeatedly performed over the predetermined time period TEREF, it is determined whether or not the integral value RT80AX is larger than a threshold value LT80A (step 151).

If the answer to the question of the step 151 is affirmative (YES) (RT80AX>LT80A), it is determined that the EGR device 51 is faulty (there is a leak from the EGR device 51), and to indicate the fact, an EGR failure flag F_EGRNG is set to 1 (step 152). On the other hand, if the answer to the question of the step 151 is negative (NO) (RT80AX≦LT80A), it is determined that the EGR device 51 is not faulty, and to indicate the fact, the EGR failure flag F_EGRNG is set to 0 (step 153).

In a step 154 following the step 152 or 153, to indicate that the EGR failure determination operation has been completed, the EGR failure determination operation completion flag F_DONEGR is set to 1. Then, the various flags related to the EGR failure determination operation are reset (step 155), followed by terminating the present process. That is, both the EGR failure determination execution condition satisfaction flag F_MCNDEGR and the EGR failure determination in-operation flag F_MIDEGR are reset to 0.

Note that in the case where the EGR failure determination operation has been completed as described above, when any of the other three determination operations (the AF variation determination operation, the sensor failure determination operation, and the catalyst deterioration determination operation) has not been completed, the execution of the processes shown in FIGS. 10 and 11 is stopped until all the other three determination operations are completed (the steps 5 and 6 in FIG. 4 are skipped). Further, when the four determination operations including the EGR failure determination operation are completed, the EGR failure determination operation completion flag F_DONEGR is reset to 0, and the execution of the processes shown in FIGS. 10 and 11 is resumed.

Next, an engine operating point control process will be described with reference to FIG. 12. The present process is a process for controlling the operating point of the engine 3 during execution of each of the three determination operations involving the purge cut, in order to continuously execute the three determination operations involving the purge cut in the above-described orders of A to D, such that the execution condition concerning the above-described operating point of the engine 3 defined in FIG. 16 is satisfied. The present process is repeatedly performed at the above-mentioned predetermined repetition period in parallel with the process shown in FIG. 4.

First, in a step 161 in FIG. 12, it is determined whether or not the AF variation determination in-operation flag F_MIDDIS is equal to 1. If the answer to this question is affirmative (YES) (F_MIDDIS=1), i.e. if the AF variation determination operation is being executed, it is determined whether or not a third determination in-operation flag F_MID3rd is equal to 1 (step 162).

The third determination in-operation flag F_MID3rd indicates that a third determination operation of the three determination operations involving the purge cut is being executed, by 1, and is set based on the AF variation determination operation completion flag F_DONDIS, the sensor failure determination operation completion flag F_DONLAF, and the EGR failure determination operation completion flag F_DONEGR. Further, the third determination in-operation flag F_MID3rd is reset to 0 when the third determination operation is completed. Furthermore, in a case where the third determination operation is suspended without being completed, the third determination in-operation flag F_MID3rd is once reset to 0, and is set to 1 when the third determination operation is resumed.

If the answer to the question of the step 162 is negative (NO) (F_MID3rd=0), i.e. if the AF variation determination operation is being executed as the first or second determination operation of the three determination operations involving the purge cut, in order to increase the possibility of the sensor failure determination operation being executed continuously from the completion of the AF variation determination operation, α β operating point control is performed (step 163), followed by terminating the present process. In the αβ operating point control, the operation mode of the drive system is set to the above-described ECVT traveling mode, and the throttle valve opening is controlled such that the operating point of the engine 3, indicated by the engine speed NE and the intake air amount GAIR, falls within a region of the operating point determination map where the region α and the region β overlap each other (FIG. 16).

Further, in the α β operating point control, when the motive power of the engine 3 controlled as described above is smaller than motive power demanded by a driver, electric power corresponding to an insufficient amount of motive power is supplied from the battery 8 to the second motor 5. On the other hand, when the motive power of the engine 3 is larger than the demanded motive power, electric power of the electric power generated by the first motor 4, corresponding to an excess amount of motive power, is charged into the battery 8. The demanded motive power is calculated by map search according to the detected accelerator pedal opening AP. The above-described control of the electric power generated by the first and second motors 4 and 5 is similarly performed also in various operating point control (steps 164, 167, 170, 173, 175 and 176), described hereinafter.

Alternatively, in the α β operating point control, the operation mode of the drive system may be set to the above-described ENG direct-connection traveling mode. In this case, since the engine speed NE is restrained by the vehicle speed VP, the throttle valve opening and the electric power generated by the first motor 4 are controlled such that the intake air amount GAIR falls within the region of the operating point determination map where the region α and the region β overlap each other (FIG. 16).

On the other hand, if the answer to the question of the step 162 is affirmative (YES) (F_MID3rd=1), i.e. if the AF variation determination operation as the third determination operation is being executed, α operating point control is performed (step 164), followed by terminating the present process. In the α operating point control, the operation mode of the drive system is set to the ECVT traveling mode, and the throttle valve opening is controlled such that the operating point of the engine 3, indicated by the engine speed NE and the intake air amount GAIR, falls within the region α of the operating point determination map.

Alternatively, in the α operating point control, the operation mode of the drive system may be set to the ENG direct-connection traveling mode. In this case, since the engine speed NE is restrained by the vehicle speed VP, the throttle valve opening and the electric power generated by the first motor 4 are controlled such that the intake air amount GAIR falls within the region α.

On the other hand, if the answer to the question of the step 161 is negative (NO) (F_MIDDIS=0), i.e. if the AF variation determination operation is not being executed, it is determined whether or not the sensor failure determination in-operation flag F_MIDLAF is equal to 1 (step 165). If the answer to this question is affirmative (YES), i.e. if the sensor failure determination operation is being executed, it is determined whether or not the first determination in-operation flag F_MID1st is equal to 1 (step 166).

If the answer to the question of the step 166 is affirmative (YES) (F_MID1st=1), i.e. if the sensor failure determination operation is being executed as a first determination operation of the three determination operations involving the purge cut, in order to increase the possibility of the EGR failure determination operation being executed continuously from the completion of the sensor failure determination operation, β γ operating point control is performed (step 167), followed by terminating the present process. In the β γ operating point control, the operation mode of the drive system is set to the ECVT traveling mode, and the throttle valve opening is controlled such that the operating point of the engine 3 falls within a region of the operating point determination map where the region β and the region γ overlap each other.

Alternatively, in the β γ operating point control, the operation mode of the drive system may be set to the ENG direct-connection traveling mode. In this case, since the engine speed NE is restrained by the vehicle speed VP, the throttle valve opening and the electric power generated by the first motor 4 are controlled such that the intake air amount GAIR falls within the region of the operating point determination map where the region β and the region γ overlap each other.

On the other hand, if the answer to the question of the step 166 is negative (NO) (F_MID1st=0), it is determined whether or not a second determination in-operation flag F_MID2nd is equal to 1 (step 168). The second determination in-operation flag F_MID2nd indicates that a determination operation which has been started second of the three determination operations involving the purge cut is being executed, by 1, and is set based on the AF variation determination in-operation flag F_MIDDIS, the sensor failure determination in-operation flag F_MIDLAF, the EGR failure determination in-operation flag F_MIDEGR, the AF variation determination operation completion flag F_DONDIS, the sensor failure determination operation completion flag F_DONLAF, and the EGR failure determination operation completion flag F_DONEGR.

Further, the second determination in-operation flag F_MID2nd is reset to 0 when the second determination operation is completed. Furthermore, in a case where the second determination operation is suspended without being completed, the second determination in-operation flag F_MID2nd is once reset to 0, and is set to 1 when the second determination operation is resumed. The second determination in-operation flag F_MID2nd is set to 1 also when the second determination operation has been suspended without being completed and a determination operation different from the suspended determination operation is started.

If the answer to the question of the step 168 is affirmative (YES) (F_MID2nd=1), i.e. if the sensor failure determination operation is being executed as a second determination operation of the three determination operations involving the purge cut, it is determined whether or not the AF variation determination operation completion flag F_DONDIS is equal to 1 (step 169).

If the answer to the question of the step 169 is negative (NO) (F_DONDIS=0), i.e. if the AF variation determination operation has not been completed, more specifically, if the EGR failure determination operation as the first determination operation has been completed, and at the same time the sensor failure determination operation as the second determination operation is being executed, in order to increase the possibility of the AF variation determination operation being executed following the completion of the sensor failure determination operation, the αβ operating point control is performed by executing the step 163, followed by terminating the present process.

On the other hand, if the answer to the question of the step 169 is affirmative (YES) (F_DONDIS=1), i.e. if the AF variation determination operation as the first determination operation has been completed, and at the same time the sensor failure determination operation as the second determination operation is being executed, the β γ operating point control is performed by executing the step 167, followed by terminating the present process.

On the other hand, if the answer to the question of the step 168 is negative (NO) (F_MId2nd=0), i.e. if the sensor failure determination operation is being executed as a third determination operation of the three determination operations involving the purge cut, the β operating point control is performed (step 170), followed by terminating the present process. In the β operating point control, the operation mode of the drive system is set to the ECVT traveling mode, and the throttle valve opening is controlled such that the operating point of the engine 3 falls within the region β of the operating point determination map.

Alternatively, in the β operating point control, the operation mode of the drive system may be set to the ENG direct-connection traveling mode. In this case, since the engine speed NE is restrained by the vehicle speed VP, the throttle valve opening and the electric power generated by the first motor 4 are controlled such that the intake air amount GAIR falls within the region β.

On the other hand, if the answer to the question of the step 165 is negative (NO) (F_MIDLAF=0), i.e. if neither of the AF variation determination operation and the sensor failure determination operation is being executed, it is determined whether or not the EGR failure determination in-operation flag F_MIDEGR is equal to 1 (step 171). If the answer to this question is negative (NO) (F_MIDEGR=0), i.e. if none of the three determination operations involving the purge cut are being performed, the present process is immediately terminated, whereas if the answer to the question of the step 171 is affirmative (YES), i.e. if the EGR failure determination operation is being executed, it is determined whether or not the first determination in-operation flag F_MID1st is equal to 1 (step 172).

If the answer to the question of the step 172 is affirmative (YES), i.e. if the EGR failure determination operation is being executed as the first determination operation of the three determination operations involving the purge cut, in order to increase the possibility of the AF variation determination operation or the sensor failure determination operation being executed following the completion of the EGR failure determination operation, the α β γ operating point control is performed (step 173), followed by terminating the present process. In the α β γ operating point control, the operation mode of the drive system is set to the ECVT traveling mode, and the throttle valve opening is controlled such that the operating point of the engine 3 falls within a region of the operating point determination map, in which one of the region α and the region β closer to the operating point of the engine 3 at the time, and the region γ overlap each other. Further, when the operating point of the engine 3 at the time falls within a region where the region α and/or the region β and the region γ overlap each other, the throttle valve opening is controlled such that the state is maintained.

Alternatively, in the α β γ operating point control, the operation mode of the drive system may be set to the ENG direct-connection traveling mode. In this case, since the engine speed NE is restrained by the vehicle speed VP, the throttle valve opening and the electric power generated by the first motor 4 are controlled such that the intake air amount GAIR falls within a region of the operating point determination map, in which one of the region α and the region β closer to the intake air amount GAIR at the time, and the region γ overlap each other. Further, when the intake air amount GAIR at the time falls within the region where the region α and/or the region β and the region γ overlap each other, the throttle valve opening and the electric power generated by the first motor 4 are controlled such that the state is maintained.

On the other hand, if the answer to the question of the step 172 is negative (NO) (F_MID1st=0), it is determined whether or not the second determination in-operation flag F_MID2nd is equal to 1 (step 174). If the answer to this question is affirmative (YES) (F_MID2nd=1), i.e. if the EGR failure determination operation is being executed as the second determination operation of the three determination operations involving the purge cut, in order to increase the possibility of the AF variation determination operation being executed following the completion of the EGR failure determination operation, α γ operating point control is performed (step 175), followed by terminating the present process. In the α γ operating point control, the operation mode of the drive system is set to the ECVT traveling mode, and the throttle valve opening is controlled such that the operating point of the engine 3 falls within a region of the operating point determination map where the region α and the region γ overlap each other.

Alternatively, in the α γ operating point control, the operation mode of the drive system may be set to the ENG direct-connection traveling mode. In this case, since the engine speed NE is restrained by the vehicle speed VP, the throttle valve opening and the electric power generated by the first motor 4 are controlled such that the intake air amount GAIR falls within the region of the operating point determination map where the region α and the region γ overlap each other.

On the other hand, if the answer to the question of the step 174 is negative (NO), i.e. if the EGR failure determination operation is being executed as the third determination operation of the three determination operations involving the purge cut, γ operating point control is performed (step 176), followed by terminating the present process. In the γ operating point control, the operation mode of the drive system is set to the ECVT traveling mode, and the throttle valve opening is controlled such that the operating point of the engine 3 falls within the region γ of the operating point determination map.

Alternatively, in the γ operating point control, the operation mode of the drive system may be set to the ENG direct-connection traveling mode. In this case, since the engine speed NE is restrained by the vehicle speed VP, the throttle valve opening and the electric power generated by the first motor 4 are controlled such that the intake air amount GAIR falls within the region γ.

Next, the catalyst deterioration-determining condition determination process performed in the step 7 in FIG. 4 will be described with reference to FIG. 13. The present process is for determining whether or not a catalyst deterioration determination execution condition (execution condition for an operation for determining a failure of the three-way catalyst 28) is satisfied.

First, in a step 181 in FIG. 13, it is determined whether or not the catalyst deterioration determination execution condition is satisfied. The catalyst deterioration determination execution condition is determined to be satisfied when the following condition a4, for example, is satisfied. Note that any other suitable condition may be further included in the catalyst deterioration determination execution condition.

a4: The operating point of the engine 3, indicated by the engine speed NE and the intake air amount GAIR, is in a region δ (FIG. 16) in the operating point determination map.

If the answer to the question of the step 181 is negative (NO), i.e. if the catalyst deterioration determination execution condition is not satisfied, to indicate the fact, a catalyst deterioration determination execution condition satisfaction flag F_MCNDCAT is set to 0 (step 182). Then, a continuous execution permission flag F_PERCAT for the catalyst deterioration determination operation is set to 0 (step 183), and the catalyst deterioration determination in-operation flag F_MIDCAT is set to 0 (step 184), followed by terminating the present process.

On the other hand, if the answer to the question of the step 181 is affirmative (YES), i.e. if the catalyst deterioration determination execution condition is satisfied, it is determined whether or not the catalyst deterioration determination in-operation flag F_MIDCAT is equal to 1 (step 185). If the answer to this question is negative (NO) (F_MIDCAT=0), to indicate that the catalyst deterioration determination execution condition is satisfied, the catalyst deterioration determination execution condition satisfaction flag F_MCNDCAT is set to 1 (step 186).

Then, it is determined whether or not a second earliest satisfaction flag F_FOU1st is equal to 1 (step 187). The second earliest satisfaction flag F_FOU1st indicates that the catalyst deterioration determination execution condition has been satisfied earlier than the AF variation determination execution condition, the sensor failure determination execution condition, and the EGR failure determination execution condition, by 1, and is set based on the AF variation determination execution condition satisfaction flag F_MCNDDIS, the sensor failure determination execution condition satisfaction flag F_MCNDLAF, and the EGR failure determination execution condition satisfaction flag F_MCNDEGR.

Further, the second earliest satisfaction flag F_FOU1st is reset to 0 when the catalyst deterioration determination operation started first is completed. Furthermore, even once the catalyst deterioration determination execution condition was satisfied first, the second earliest satisfaction flag F_FOU1st is reset to 0, when the catalyst deterioration determination execution condition has ceased to be satisfied before the start of the catalyst deterioration determination operation, and the AF variation determination execution condition, the sensor failure determination execution condition, or the EGR failure determination execution condition is satisfied.

If the answer to the question of the step 187 is affirmative (YES) (F_FOU1st=1), i.e. if the catalyst deterioration determination execution condition has been satisfied earlier than the AF variation determination execution condition, the sensor failure determination execution condition, and the EGR failure determination execution condition, to start the catalyst deterioration determination operation, the catalyst deterioration determination in-operation flag F_MIDCAT is set to 1 (step 188), followed by terminating the present process. By executing the step 188, the answer to the question of the step 185 becomes affirmative (YES), and in this case, the present process is immediately terminated.

On the other hand, if the answer to the question of the step 187 is negative (NO) (F_FOU1st=0), i.e. if any of the AF variation determination execution condition, the sensor failure determination execution condition, and the EGR failure determination execution condition has been satisfied earlier than the catalyst deterioration determination execution condition, it is determined whether or not an earliest determination operation started flag F_STA1st is equal to 1 (step 189). The earliest determination operation started flag F_STA1st indicates that the first determination operation of the three determination operations involving the purge cut has been started, by 1, and is set based on the AF variation determination in-operation flag F_MIDDIS, the sensor failure determination in-operation flag F_MIDLAF, and the EGR failure determination in-operation flag F_MIDEGR.

If the answer to the question of the step 189 is negative (NO) (F_STA1st=0), the step 184 is executed, followed by terminating the present process. On the other hand, if the answer to the question of the step 189 is affirmative (YES), i.e. if a determination operation the execution condition for which has been satisfied first has been started, a second continuous execution permission process is performed (step 190).

FIG. 14 shows the second continuous execution permission process. The present process permits/inhibits the catalyst deterioration determination operation to be executed/from being executed following the completion of the first or second determination operation of the three determination operations involving the purge cut. First, in a step 201 in FIG. 14, it is determined whether or not a third determination operation completion flag F_DON3rd is equal to 1. The third determination operation completion flag F_DON3rd indicates that all the three determination operations involving the purge cut have been completed, by 1, and is set based on the AF variation determination operation completion flag F_DONDIS, the sensor failure determination operation completion flag F_DONLAF, and the EGR failure determination operation completion flag F_DONEGR. Further, the third determination operation completion flag F_DON3rd is reset to 0 when all of the three determination operations involving the purge cut and the catalyst deterioration determination operation have been completed.

If the answer to the question of the step 201 is negative (NO) (F_DON3rd=0), i.e. if any of the three determination operations involving the purge cut has not been completed, it is determined whether or not a first determination in-operation flag F_F_MID1st is equal to 1 (step 202). In this case, the answer to the question of the step 189 in FIG. 13 is affirmative (YES) (F_STA1st=1), which means that the first determination operation has already been started, and hence until the first determination operation is completed, the answer to the question of the step 202 is affirmative (YES) (F_F_MID1st=1). If the answer to the question of the step 202 is affirmative (YES), i.e. if the first determination operation of the three determination operations including the purge is being performed, it is determined whether or not the AF variation determination in-operation flag F_MIDDIS is equal to 1 (step 203).

If the answer to the question of the step 203 is affirmative (YES) (F_MIDDIS=1), i.e. if the AF variation determination operation is being executed as the first determination operation, it is determined whether or not the sensor failure determination execution condition satisfaction flag F_MCNDLAF is equal to 1 (step 204). If the answer to this question is negative (NO) (F_MCNDLAF=0), i.e. if the sensor failure determination execution condition has not been satisfied during execution of the AF variation determination operation as the first determination operation, to permit the catalyst deterioration determination operation to be executed following the completion of the AF variation determination operation, the continuous execution permission flag F_PERCAT for the catalyst deterioration determination operation is set to 1 (step 205), followed by terminating the present process.

On the other hand, if the answer to the question of the step 204 is affirmative (YES) (F_MCNDLAF=1), i.e. if the sensor failure determination execution condition has been satisfied during execution of the AF variation determination operation as the first determination operation, to inhibit the catalyst deterioration determination operation from being executed following the completion of the AF variation determination operation, the continuous execution permission flag F_PERCAT for the catalyst deterioration determination operation is set to 0 (step 206), followed by terminating the present process.

On the other hand, if the answer to the question of the step 203 is negative (NO) (F_MIDDIS=0), it is determined whether or not the sensor failure determination in-operation flag F_MIDLAF is equal to 1 (step 207). If the answer to this question is affirmative (YES) (F_MIDLAF=1), i.e. if the sensor failure determination operation as the first determination operation is being executed, it is determined whether or not the EGR failure determination execution condition satisfaction flag F_MCNDEGR is equal to 1 (step 208).

If the answer to the question of the step 208 is negative (NO) (F_MCNDEGR=0), i.e. if the EGR failure determination execution condition has not been satisfied during execution of the sensor failure determination operation as the first determination operation, to permit the catalyst deterioration determination operation to be executed following the completion of the sensor failure determination operation, the step 205 is executed, followed by terminating the present process.

On the other hand, if the answer to the question of the step 208 is affirmative (YES) (F_MCNDEGR=1), i.e. if the EGR failure determination execution condition has been satisfied during execution of the sensor failure determination operation as the first determination operation, to inhibit the catalyst deterioration determination operation from being executed following the completion of the sensor failure determination operation, the step 206 is executed, followed by terminating the present process.

On the other hand, if the answer to the question of the step 207 is negative (NO), i.e. if the EGR failure determination operation as the first determination operation is being executed, it is determined in steps 209 and 210 whether or not the AF variation determination execution condition satisfaction flag F_MCNDDIS and the sensor failure determination execution condition satisfaction flag F_MCNDLAF are equal to 1, respectively. If both of the answers to these questions are negative (NO), i.e. if neither of the AF variation determination execution condition and the sensor failure determination execution condition is satisfied during execution of the EGR failure determination operation as the first determination operation, to permit the catalyst deterioration determination operation to be executed following the completion of the EGR failure determination operation, the step 205 is executed, followed by terminating the present process.

On the other hand, if one of the answers to the questions of the steps 209 and 210 is affirmative (YES), i.e. if one of the AF variation determination execution condition and the sensor failure determination execution condition has been satisfied during execution of the EGR failure determination operation as the first determination operation, to inhibit the catalyst deterioration determination operation from being executed following the completion of the EGR failure determination operation, the step 206 is executed, followed by terminating the present process.

On the other hand, if the answer to the question of the step 202 is negative (NO) (F_MID1st=0), it is determined whether or not a second determination operation completion flag F_DON2nd is equal to 1 (step 211). The second determination operation completion flag F_DON2nd indicates that the first and second determination operations of the three determination operations including the purge cut have been completed, by 1, and is set based on the AF variation determination operation completion flag F_DONDIS, the sensor failure determination operation completion flag F_DONLAF, and the EGR failure determination operation completion flag F_DONEGR. Further, the second determination operation completion flag F_DON2nd is reset to 0 when all of the three determination operations involving the purge cut and the catalyst deterioration determination operation have been completed.

If the answer to the question of the step 211 is negative (NO) (F_DON2nd=0), the present process is immediately terminated, whereas if the answer to the question of the step 211 is affirmative (YES), i.e. if the first and second determination operations of the three determination operations including the purge cut have been completed, it is determined whether or not a first order flag F_ORDER1 is equal to 1 (step 212).

The first order flag F_ORDER1 represents that the first and second determination operations have been completed in the above-mentioned order A, i.e. in the order of the AF variation determination operation→the sensor failure determination operation, by 1, and is set based on the AF variation determination operation completion flag F_DONDIS, the sensor failure determination operation completion flag F_DONLAF, and the EGR failure determination operation completion flag F_DONEGR. Further, the first order flag F_ORDER1 is reset to 0 when all of the three determination operations involving the purge cut and the catalyst deterioration determination operation have been completed.

If the answer to the question of the step 212 is affirmative (YES) (F_ORDER1=1), it is determined whether or not the EGR failure determination execution condition satisfaction flag F_MCNDEGR is equal to 1 (step 213). If the answer to this question is negative (NO) (F_MCNDEGR=0), i.e. if the determination operations have been completed in the order of the AF variation determination operation→the sensor failure determination operation, and at the same time the EGR failure determination execution condition has not been satisfied, to permit the catalyst deterioration determination operation to be executed following the completion of the sensor failure determination operation as the second determination operation, the step 205 is executed, followed by terminating the present process.

On the other hand, if the answer to the question of the step 213 is affirmative (YES) (F_MCNDEGR=1), i.e. if the determination operations have been completed in the order of the AF variation determination operation→the sensor failure determination operation, and at the same time the EGR failure determination execution condition has been satisfied, to inhibit the catalyst deterioration determination operation from being executed following the completion of the sensor failure determination operation as the second determination operation, the step 206 is executed, followed by terminating the present process.

On the other hand, if the answer to the question of the step 212 is negative (NO) (F_ORDER1=0), it is determined whether or not a second order flag F_ORDER2 is equal to 1 (step 214). The second order flag F_ORDER2 represents that the first and second determination operations have been completed in the above-mentioned order B, i.e. in the order of the sensor failure determination operation→the EGR failure determination operation, by 1, and is set based on the AF variation determination operation completion flag F_DONDIS, the sensor failure determination operation completion flag F_DONLAF, and the EGR failure determination operation completion flag F_DONEGR. Further, the second order flag F_ORDER2 is reset to 0 when all of the three determination operations involving the purge cut and the catalyst deterioration determination operation have been completed.

If the answer to the question of the step 214 is affirmative (YES) (F_ORDER2=1), it is determined whether or not the AF variation determination execution condition satisfaction flag F_MCNDDIS is equal to 1 (step 215). If the answer to this question is negative (NO) (F_MCNDDIS=0), i.e. if the determination operations have been completed in the order of the sensor failure determination operation→the EGR failure determination operation, and at the same time the AF variation determination execution condition has not been satisfied, to permit the catalyst deterioration determination operation to be executed following the completion of the EGR failure determination operation as the second determination operation, the step 205 is executed, followed by terminating the present process.

On the other hand, if the answer to the question of the step 215 is affirmative (YES) (F_MCNDDIS=1), i.e. if the determination operations have been completed in the order of the sensor failure determination operation→the EGR failure determination operation, and at the same time the AF variation determination execution condition has been satisfied, to inhibit the catalyst deterioration determination operation from being executed following the completion of the EGR failure determination operation as the second determination operation, the step 206 is executed, followed by terminating the present process.

On the other hand, if the answer to the question of the step 214 is negative (NO) (F_ORDER2=0), it is determined whether or not a third order flag F_ORDER3 is equal to 1 (step 216). The third order flag F_ORDER3 represents that the first and second determination operations have been completed in the above-mentioned order C, i.e. in the order of the EGR failure determination operation→the sensor failure determination operation, by 1, and is set based on the AF variation determination operation completion flag F_DONDIS, the sensor failure determination operation completion flag F_DONLAF, and the EGR failure determination operation completion flag F_DONEGR. Further, the third order flag F_ORDER3 is reset to 0 when all of the three determination operations involving the purge cut and the catalyst deterioration determination operation have been completed.

If the answer to the question of the step 216 is affirmative (YES) (F_ORDER3=1), i.e. if the first and second determination operations have been completed in the order of the EGR failure determination operation→the sensor failure determination operation, the step 215 et seq. are executed. With this, when the determination operations have been completed in the order of the EGR failure determination operation→the sensor failure determination operation, and at the same time the AF variation determination execution condition has not been satisfied, the catalyst deterioration determination operation is permitted to be executed continuously from the completion of the sensor failure determination operation. On the other hand, when the AF variation determination execution condition has been satisfied, the catalyst deterioration determination operation is inhibited from being executed following the completion of the sensor failure determination operation.

On the other hand, if the answer to the question of the step 216 is negative (NO) (F_ORDER3=0), i.e. if the first and second determination operations have been completed in the above-mentioned order D (the EGR failure determination operation→the AF variation determination operation), it is determined whether or not the sensor failure determination execution condition satisfaction flag F_MCNDLAF is equal to 1 (step 217). If the answer to this question is negative (NO) (F_MCNDLAF=0), i.e. if the determination operations have been completed in the order of the EGR failure determination operation→the AF variation determination operation, and at the same time the sensor failure determination execution condition has not been satisfied, to permit the catalyst deterioration determination operation to be executed following the completion of the AF variation determination operation as the second determination operation, the step 205 is executed, followed by terminating the present process.

On the other hand, if the answer to the question of the step 217 is affirmative (YES) (F_MCNDLAF=1), i.e. if the determination operations have been completed in the order of the EGR failure determination operation→the AF variation determination operation, and at the same time the sensor failure determination execution condition has been satisfied, to inhibit the catalyst deterioration determination operation from being executed following the completion of the AF variation determination operation as the second determination operation, the step 206 is executed, followed by terminating the present process.

On the other hand, if the answer to the question of the step 201 is affirmative (YES) (F_DON3rd=1), i.e. if all the three determination operations involving the purge cut have been completed, to permit the catalyst deterioration determination operation to be executed following the completion of the third determination operation, the step 205 is executed, followed by terminating the present process.

Referring again to FIG. 13, in a step 191 following the step 190, it is determined whether or not the continuous execution permission flag F_PERCAT set in the step 205 or 206 in FIG. 14 is equal to 1. If the answer to the question of the step 191 is negative (NO) (F_PERCAT=0), i.e. if the catalyst deterioration determination operation is inhibited from being executed continuously from the completion of the first or second determination operation, the step 184 is executed, followed by terminating the present process.

On the other hand, if the answer to the question of the step 191 is affirmative (YES) (F_PERCAT=1), i.e. if the catalyst deterioration determination operation is permitted to be executed continuously from the completion of the first or second determination operation, it is determined in the steps 192, 193, 194 whether or not the AF variation determination in-operation flag F_MIDDIS, the sensor failure determination in-operation flag F_MIDLAF, and the EGR failure determination in-operation flag F_MIDEGR are equal to 1, respectively.

If any of the answers to the questions of the steps 192 to 194 is affirmative (YES), i.e. if any of the AF variation determination operation, the sensor failure determination operation, and the EGR failure determination operation is being executed, to hold the catalyst deterioration determination operation, the step 184 is performed, followed by terminating the present process. On the other hand, if all the answers to the questions of the steps 192 to 194 are negative (NO), the step 188 is performed, followed by terminating the present process.

Further, FIG. 15 shows the catalyst deterioration determination process performed in the step 8 in FIG. 4. The present process is for executing the catalyst deterioration determination operation.

First, in a step 221 in FIG. 15, it is determined whether or not the catalyst deterioration determination in-operation flag F_MIDCAT set in the step 184 or 188 in FIG. 13 is equal to 1. If the answer to this question is negative (NO), the present process is immediately terminated, whereas if the answer to the question of the step 221 is affirmative (YES) (F_MIDCAT=1), the catalyst deterioration determination operation is executed in the following step 222 et seq.

First, in the step 222, to allow supply of evaporated fuel by the evaporated fuel processor 31, the purge cut flag F_PURCUT is set to 0. Then, the deterioration of the three-way catalyst 28 is determined (step 223). More specifically, the fuel injection amount is controlled such that a detection signal SVO2 from the O2 sensor 67 becomes equal to a value corresponding to the stoichiometric air-fuel ratio, and during the control of the fuel injection amount, when an average value of an inversion period of the detection signal SVO2 becomes equal to or smaller than a predetermined value, it is determined that the three-way catalyst 28 is deteriorated.

Then, it is determined whether or not the catalyst deterioration determination operation has been completed (step 224). If the answer to this question is negative (NO), the present process is immediately terminated, whereas if the answer to the question of the step 224 is affirmative (YES), to indicate that the catalyst deterioration determination operation has been completed, a catalyst deterioration determination operation completion flag F_DONCAT is set to 1 (step 225). Then, the various flags related to the catalyst deterioration determination operation are reset (step 226), followed by terminating the present process. That is, the catalyst deterioration determination execution condition satisfaction flag F_MCNDCAT, the continuous execution permission flag F_PERCAT, and the catalyst deterioration determination in-operation flag F_MIDCAT are reset to 0.

Note that in the case where the catalyst deterioration determination operation has been completed as described above, when any of the other three determination operations (the AF variation determination operation, the sensor failure determination operation, and the EGR failure determination operation) has not been completed, the execution of the processes shown in FIGS. 13 and 15 is stopped until all the other three determination operations are completed (the steps 7 and 8 in FIG. 4 are skipped). Further, when the four determination operations including the catalyst deterioration determination operation have been completed, the catalyst deterioration determination operation completion flag F_DONCAT is reset to 0, and the execution of the processes shown in FIGS. 13 and 15 is resumed.

Next, an example of operation performed by the abnormality determination device according to the first embodiment will be described with reference to FIGS. 17 to 22. FIG. 17 shows an example of operation in a case where the three determination operations involving the purge cut are continuously executed in the order A (the AF variation determination operation→the sensor failure determination operation→the EGR failure determination operation).

As described hereinabove, during execution of the AF variation determination operation, the EGR cut flag F_EGRCUT is set to 1 (the step 65 in FIG. 7), whereby the EGR control valve opening OEV is controlled to the fully-closed state (=0). Further, although the sensor failure determination execution condition (including the conditions a2 to c2) includes no conditions concerning the EGR device 51, the EGR failure determination execution condition includes the condition b3 that exhaust gases have been recirculated by the EGR device 51 before the start of the EGR failure determination operation (or, recirculation of exhaust gases can be executed).

From the above, as shown in FIG. 17, during execution of the AF variation determination operation (time point t1 and thereafter, F_MIDDIS=1), the EGR failure determination execution condition is not satisfied, and the EGR failure determination execution condition satisfaction flag F_MCNDEGR is held at 0. Further, as described with reference to FIG. 12, during execution of the AF variation determination operation as the first determination operation of the three determination operations involving the purge cut (YES to the step 161, NO to the step 162), the α β operating point control is performed (the step 163). As a consequence, during execution of the AF variation determination operation, the operating point of the engine 3 is controlled to fall within the region where the region α and the region β overlap each other in the operating point determination map shown in FIG. 16.

During execution of the AF variation determination operation, when the sensor failure determination execution condition is satisfied (time point t2), in accordance with this, the sensor failure determination execution condition satisfaction flag F_MCNDLAF is set to 1 (the step 89 in FIG. 8). Even when the sensor failure determination execution condition is satisfied, unless the stabilization time TMSTE elapses after the satisfaction of the sensor failure determination execution condition (NO to the step 91 in FIG. 8), or insofar as the AF variation determination operation is being executed (YES to the step 96), the sensor failure determination in-operation flag F_MIDLAF is set to 0 (the step 87), whereby the sensor failure determination operation is held (NO to the step 101 in FIG. 9).

Then, when the AF variation determination operation has been completed as the first determination operation (time point t3), in accordance with this, the AF variation determination operation completion flag F_DONDIS is set to 1 (the step 76 in FIG. 7), and the AF variation determination execution condition satisfaction flag F_MCNDDIS and the AF variation determination in-operation flag F_MIDDIS are reset to 0 (the step 77). When the AF variation determination operation is completed, if the sensor failure determination execution condition has been satisfied (YES to the step 81 in FIG. 8), and at the same time the stabilization time TMSTE has elapsed after the satisfaction of the sensor failure determination execution condition (YES to the step 91), the sensor failure determination in-operation flag F_MIDLAF is set to 1 (NO to the steps 96 and 97; the step 98, in FIG. 8), and holding of the sensor failure determination operation is released. As a consequence, the sensor failure determination operation is started as a second determination operation (YES to the step 101 in FIG. 9).

Further, in this example of operation, in accordance with the completion of the AF variation determination operation, the EGR failure determination execution condition is satisfied (F_MCNDEGR←1). However, as is apparent from the steps executed in the EGR failure-determining condition determination process (FIG. 10), even when the EGR failure determination execution condition has been satisfied, if the stabilization time TMSTE has not elapsed after the satisfaction of the EGR failure determination execution condition, the EGR failure determination in-operation flag F_MIDEGR is held at 0 (NO to the step 131; the step 127, in FIG. 10), whereby the EGR failure determination operation is held (NO to the step 141 in FIG. 11). Further, even after the stabilization time TMSTE has elapsed after the satisfaction of the EGR failure determination execution condition, the EGR failure determination in-operation flag F_MIDEGR is held at 0 during execution of the sensor failure determination operation (YES to the step 136; the step 127, in FIG. 10). In this case as well, the EGR failure determination operation is held.

Further, as described with reference to FIG. 12, after the AF variation determination operation has been completed as the first determination operation, when the sensor failure determination operation is being executed as the second determination operation (YES to the steps 168 and 169), the β γ operating point control is performed (the step 167). With this, during execution of the sensor failure determination operation, the operating point of the engine 3 is controlled to fall within the region where the region β and the region γ overlap each other in the operating point determination map.

Then, when the sensor failure determination operation is completed as the second determination operation (time point t4), in accordance with this, the sensor failure determination operation completion flag F_DONLAF is set to 1 (the step 113 in FIG. 9), and the sensor failure determination execution condition satisfaction flag F_MCNDLAF and the sensor failure determination in-operation flag F_MIDLAF are reset to 0 (the step 114). When the sensor failure determination operation is completed, if the EGR failure determination execution condition has been satisfied (YES to the step 121 in FIG. 10), and at the same time the stabilization time TMSTE has elapsed after the satisfaction of the EGR failure determination execution condition (YES to the step 131), the EGR failure determination in-operation flag F_MIDEGR is set to 1 (NO to the step 136; the step 137), whereby holding of the EGR failure determination operation is released. As a consequence, the EGR failure determination operation is started as a third determination operation (YES to the step 141 in FIG. 11).

Further, during execution of the EGR failure determination operation, the EGR control intended for determination is performed (the step 144), whereby the EGR control valve opening OEV is repeatedly controlled to open and close the EGR control valve 53 a plurality of times at a fixed repetition period (or a single time).

Then, when the EGR failure determination operation as the third determination operation is completed (time point t5), in accordance with this, the EGR failure determination operation completion flag F_DONEGR is set to 1 (the step 154 in FIG. 11), and the EGR failure determination execution condition satisfaction flag F_MCNDEGR and the EGR failure determination in-operation flag F_MIDEGR are reset to 0 (the step 155).

Further, as is apparent from the steps executed in the AF variation determination process (FIG. 7), the sensor failure determination process (FIG. 9), and the EGR failure determination process (FIG. 11), during execution of the AF variation determination operation, the sensor failure determination operation, and the EGR failure determination operation, the purge cut flag F_PURCUT is set to 1, whereby the purge cut is executed (the steps 63, 103, and 143), so that a purge flow rate QPU becomes equal to 0.

As is apparent from the steps 15 to 17 in FIG. 5, the steps 84 to 86 in FIG. 8, and the steps 124 to 126 in FIG. 10, in spite of one of the three determination operations involving the purge cut being completed, insofar as the execution condition for a determination operation to be executed next remains satisfied, the purge cut flag F_PURCUT is held at 1 without being switched to 0. With this, as shown in FIG. 17, the purge cut is continued, and the purge flow rate QPU is held at 0 until the EGR failure determination operation as the third determination operation is completed after the start of the AF variation determination operation as the first determination operation. Further, although not shown, when the three determination operations involving the purge cut have been completed, the purge cut flag F_PURCUT is reset to 0, whereafter unless the three determination operations involving the purge cut are executed again, the evaporated fuel processor 31 is controlled according to the operating state (NE and so forth) of the engine 3. The above settings of the purge cut flag F_PURCUT similarly apply to other examples, described hereinafter, of operation according to the first embodiment.

Further, FIG. 18 shows an example of operation in a case where the three determination operations involving the purge cut are continuously executed in the order B (the sensor failure determination operation→the EGR failure determination operation→the AF variation determination operation).

As described hereinabove, during execution of the sensor failure determination operation, the EGR control valve opening OEV is controlled according to the operating state of the engine 3. Therefore, in the example of operation illustrated in FIG. 18, during execution of the sensor failure determination operation (time point t6 and thereafter, F_MIDLAF=1), the EGR control valve opening OEV becomes larger than 0.

Further, as described with reference to FIG. 12, during execution of the sensor failure determination operation as a first determination operation (YES to the steps 165 and 166), the β γ operating point control is performed (the step 167). With this, during execution of the sensor failure determination operation, the operating point of the engine 3 is controlled to fall within the region where the region β and the region γ overlap each other in the operating point determination map, but before that, the operating point sometimes fall within the region where the region α and the region β overlap each other in the operating point determination map. In the example of operation illustrated in FIG. 18, during execution of the sensor failure determination operation, the AF variation determination execution condition is satisfied earlier than the EGR failure determination execution condition, and in accordance with this, the AF variation determination execution condition satisfaction flag F_MCNDDIS is set to 1 (time point t7).

Further, during execution of the sensor failure determination operation, when the EGR failure determination execution condition is not satisfied (F_MCNDEGR=0), the continuous execution permission flag F_PERDIS for the AF variation determination operation is set to 1 (YES to the steps 41 and 46, NO to the step 47; the step 45, in FIG. 6), whereas when the EGR failure determination execution condition is satisfied (time point t8, F_MCNDEGR←1), the continuous execution permission flag F_PERDIS is accordingly switched to 0 (YES to the steps 41, 46, and 47; the step 48). In this case, the continuous execution permission flag F_PERDIS is held at 0 after completion of the sensor failure determination operation as the first determination operation, until the completion of the EGR failure determination operation as a second determination operation (NO to the step 41, YES to the step 42, NO to the step 49; the step 48).

The continuous execution permission flag F_PERDIS is set as described above, whereby the AF variation determination in-operation flag F_MIDDIS is set to 0 until the EGR failure determination operation is completed after the EGR failure determination execution condition is satisfied during execution of the sensor failure determination operation (NO to the step 23; the step 18, in FIG. 5). As a consequence, the AF variation determination operation is inhibited from being executed following the completion of the sensor failure determination operation as the first determination operation (NO to the step 61 in FIG. 7).

Further, similar to the example of operation illustrated in FIG. 17, even after the stabilization time TMSTE has elapsed after the satisfaction of the EGR failure determination execution condition, during execution of the sensor failure determination operation, the EGR failure determination operation is held (F_MIDEGR←0).

Furthermore, similar to the example of operation illustrated in FIG. 17, at the time of the completion of the sensor failure determination operation (time point t9, F_DONLAF←1, F_MCNDLAF←0, F_MIDLAF←0, in FIG. 18), when the EGR failure determination execution condition has been satisfied, and also the stabilization time TMSTE has elapsed after the satisfaction of the EGR failure determination execution condition, the holding of the EGR failure determination operation is released (F_MIDEGR←1). As a consequence, the EGR failure determination operation is started as the second determination operation.

Further, as described with reference to FIG. 12, during execution of the EGR failure determination operation as the second determination operation (YES to the step 171, NO to the step 172, YES to the step 174), the α γ operating point control is performed (the step 175). With this, during execution of the EGR failure determination operation, the operating point of the engine 3 is controlled to fall within the region where the region γ and the region α overlap each other in the operating point determination map.

Furthermore, at the time of the completion of the EGR failure determination operation as the second determination operation (time point t10, F_DONEGR←1, F_MCNDEGR←0, F_MIDEGR←0, in FIG. 18), when the AF variation determination execution condition has been satisfied (F_MCNDDIS=1), the continuous execution permission flag F_PERDIS is switched to 1 (YES to the steps 43 and 51; the step 45, in FIG. 6), and the inhibition of execution of the AF variation determination operation is released (YES to the step 23 in FIG. 5). Further, at the time of the completion of the EGR failure determination operation (the time point t10), since the stabilization time TMSTE has elapsed after the satisfaction of the AF variation determination execution condition, the AF variation determination in-operation flag F_MIDDIS is set to 1 (YES to the step 25, NO to the steps 30 and 31; the step 32, in FIG. 5). As a consequence, the AF variation determination operation is started as a third determination operation (YES to the step 61 in FIG. 7).

Then, when the AF variation determination operation as the third determination operation is completed (time point t11 in FIG. 18), in accordance therewith, similar to the example of operation illustrated in FIG. 17, the various flags related to the AF variation determination operation are set (F_DONDIS←1, F_MCNDDIS←0, F_MIDDIS←0).

Further, FIG. 19 shows an example of operation in a case where the three determination operations involving the purge cut are continuously executed in the order C (the EGR failure determination operation→the sensor failure determination operation→the AF variation determination operation).

As described with reference to FIG. 12, during execution of the EGR failure determination operation as a first determination operation (YES to the steps 171 and 172), the α β γ operating point control is performed (the step 173). With this, during execution of the EGR failure determination operation, the operating point of the engine 3 is controlled to fall within the region of the operating point determination map where one of the region α and the region β closer to the operating point of the engine 3 at the time, and the region γ overlap each other.

In the example of operation illustrated in FIG. 19, during execution of the EGR failure determination operation as a first determination operation (time point t12 and thereafter, F_MIDEGR=1), first, the sensor failure determination execution condition satisfaction flag F_MCNDLAF is set to 1 in accordance with the satisfaction of the sensor failure determination execution condition (time point t13), and then in accordance with the satisfaction of the AF variation determination execution condition, the AF variation determination execution condition satisfaction flag F_MCNDDIS is set to 1 (time point t14).

As described with reference to FIG. 6, during execution of the EGR failure determination operation as the first determination operation, when the sensor failure determination execution condition has been satisfied earlier than the AF variation determination execution condition, the continuous execution permission flag F_PERDIS is set to 0 (YES to the steps 42, 49, and 50, the step 48). In this case, from the completion of the EGR failure determination operation as the first determination operation to the completion of the sensor failure determination operation as a second determination operation, the continuous execution permission flag F_PERDIS is held at 0 (YES to the steps 44 and 50; step 48; YES to the step 41, NO to the step 46).

The continuous execution permission flag F_PERDIS is set as described above, whereby the AF variation determination in-operation flag F_MIDDIS is set to 0 until the sensor failure determination is completed after the sensor failure determination execution condition operation is satisfied during execution of the EGR failure determination operation (NO to the step 23; the step 18, in FIG. 5). As a consequence, the AF variation determination operation is inhibited from being executed following the completion of the EGR failure determination operation as the first determination operation (NO to the step 61 in FIG. 7).

Further, similar to the example of operation illustrated in FIG. 17, even after the stabilization time TMSTE has elapsed after the satisfaction of the sensor failure determination execution condition, during execution of the EGR failure determination operation, the sensor failure determination operation is held (F_MIDLAF←0).

Furthermore, at the time of the completion of the EGR failure determination operation as the first determination operation (time point t15, F_DONEGR←1, F_MCNDEGR←0, F_MIDEGR←0), when the stabilization time TMSTE has elapsed after the satisfaction of the sensor failure determination execution condition, the holding of the sensor failure determination operation is released (F_MIDLAF←1). As a consequence, the sensor failure determination operation is started as the second determination operation.

Further, as described with reference to FIG. 12, after the completion of the EGR failure determination operation as the first determination operation, during execution of the sensor failure determination operation as the second determination operation (YES to the step 165, NO to the step 166, YES to the step 168, NO to the step 169), the αβ operating point control is performed (the step 163). With this, during execution of the sensor failure determination operation, the operating point of the engine 3 is controlled to fall within the region where the region β and the region α overlap each other in the operating point determination map.

Furthermore, at the time of the completion of the sensor failure determination operation as the second determination operation (time point t16, F_DONLAF←1, F_MCNDLAF←0, F_MIDLAF←0, in FIG. 19), when the AF variation determination execution condition has been satisfied (F_MCNDDIS=1), similar to the example of operation illustrated in FIG. 18, the continuous execution permission flag F_PERDIS is switched to 1, and the inhibition of execution of the AF variation determination operation is released. Further, at the time of the completion of the sensor failure determination operation, since the stabilization time TMSTE has elapsed after the satisfaction of the AF variation determination execution condition, the AF variation determination operation is started as a third determination operation, similar to the example of operation illustrated in FIG. 18.

Then, when the AF variation determination operation as the third determination operation is completed (time point t17), in accordance therewith, the various flags related to the AF variation determination operation are set (F_DONDIS←1, F_MCNDDIS←0, F_MIDDIS←0).

In this connection, differently from the example of operation illustrated in FIG. 19, during execution of the EGR failure determination operation as the first determination operation, the AF variation determination execution condition is sometimes satisfied earlier than the sensor failure determination execution condition. In such a case, the AF variation determination operation is permitted to be executed following the completion of the EGR failure determination operation (NO to the step 50; the step 45, in FIG. 6). In this case, although a continuous execution permission flag for the sensor failure determination operation is not set, the determinations are performed, as shown in FIG. 4, in the order of the AF variation-determining condition determination process→the AF variation determination process→the sensor failure-determining condition determination process→the sensor failure determination process, so that the AF variation determination operation for which the execution condition has been satisfied earlier is started earlier than the sensor failure determination operation.

Further, FIG. 20 shows an example of operation in a case where the three determination operations involving the purge cut are continuously executed in the order D (the EGR failure determination operation→the AF variation determination operation→the sensor failure determination operation), and the catalyst deterioration determination execution condition is satisfied during execution of the EGR failure determination operation as a first determination operation.

During execution of the EGR failure determination operation as the first determination operation, similar to the example of operation illustrated in FIG. 19, the a βγ operating point control is performed. Further, as shown in FIG. 20, during execution of the EGR failure determination operation (time point t18 and thereafter, F_MIDEGR=1, F_MID1st=1), when the catalyst deterioration determination execution condition is satisfied (time point t19), in accordance therewith, the catalyst deterioration determination execution condition satisfaction flag F_MCNDCAT is set to 1 (the step 186 in FIG. 13). Since neither of the AF variation determination execution condition and the sensor failure determination execution condition has been satisfied at this time point (F_MCNDDIS=0 and at the same time F_MCNDLAF=0), the continuous execution permission flag F_PERCAT for the catalyst deterioration determination operation is set to 1 (YES to the step 202, NO to the steps 203 and 207, NO to the steps 209 and 210; the step 205, in FIG. 14).

Further, during execution of the EGR failure determination operation as the first determination operation, when the AF variation determination execution condition is satisfied (time point t20, F_MCNDDIS←1), the continuous execution permission flag F_PERCAT is switched to 0 (YES to the step 209; the step 206, in FIG. 14), and is held at 0 insofar as the AF variation determination execution condition remains satisfied. Further, the continuous execution permission flag F_PERCAT is held at a value immediately before the completion of the first determination operation, until a second determination operation is completed after the completion of the first determination operation (NO to the steps 202 and 211).

The continuous execution permission flag F_PERCAT is set as described above, whereby the catalyst deterioration determination in-operation flag F_MIDCAT is set to 0 until the AF variation determination operation is completed after the AF variation determination execution condition is satisfied during execution of the EGR failure determination operation (NO to the step 191; the step 184, in FIG. 13). As a consequence, the catalyst deterioration determination operation is inhibited from being executed following the completion of the EGR failure determination operation as the first determination operation (NO to the step 221 in FIG. 15). In this case, as is apparent from the steps executed in the second continuous execution permission process (FIG. 14), and further as shown in FIG. 20, even in the case where the catalyst deterioration determination execution condition is satisfied earlier than the AF variation determination execution condition, the catalyst deterioration determination operation is inhibited from being executed following the completion of the EGR failure determination operation. Further, during execution of the EGR failure determination operation, even when the AF variation determination execution condition is satisfied, similar to the example of the operation shown in FIG. 17 etc., the AF variation determination operation is held (F_MIDDIS←0).

When the EGR failure determination operation as the first determination operation has been completed (time point t21, F_MIDEGR←0, F_MID1st←0), in this example, the stabilization time TMSTE has elapsed after the satisfaction of the AF variation determination execution condition, and hence in accordance with the completion of the EGR failure determination operation, the AF variation determination operation as the second determination operation is started (F_MIDDIS←1). During execution of the AF variation determination operation, when the sensor failure determination execution condition is satisfied (time point t22), in accordance therewith, the sensor failure determination execution condition satisfaction flag F_MCNDLAF is set to 1.

Further, during execution of the AF variation determination operation, even when the sensor failure determination execution condition is satisfied, similar to the example of the operation shown in FIG. 17 and the like, the sensor failure determination operation is held (F_MIDLAF←0). Further, as described with reference to FIG. 12, during execution of the AF variation determination operation as the second determination operation (YES to the step 161, NO to the step 162), the αβ operating point control is performed (the step 163).

In a case where the AF variation determination operation as the second determination operation has been completed (time point t23, F_MCNDDIS←0, F_MIDDIS←0, F_DON2nd=1), when the sensor failure determination execution condition is satisfied (F_MCNDLAF=1), the continuous execution permission flag F_PERCAT continues to be held at 0 (YES to the step 211, NO to the steps 212, 214, and 216, YES to the step 217; the step 206, in FIG. 14). This also inhibits the catalyst deterioration determination operation from being executed following the completion of the AF variation determination operation. Further, at the time of the completion of the AF variation determination operation (the time point t23), since the stabilization time TMSTE has elapsed after the satisfaction of the sensor failure determination execution condition, the sensor failure determination operation as a third determination operation is started (F_MIDLAF←1).

Then, in the state in which the catalyst deterioration determination execution condition has been satisfied (F_MCNDCAT=1), when the sensor failure determination operation as the third determination operation is completed (F_MCNDLAF←0, F_MIDLAF←0), causing the third determination operation completion flag F_DON3rd to be set to 1 (time point t24), the continuous execution permission flag F_PERCAT is switched to 1 in accordance therewith (YES to the step 201; the step 205, in FIG. 14). This releases the inhibition of the catalyst deterioration determination operation from being executed following the completion of the sensor failure determination operation (YES to the step 191), and in accordance therewith, the catalyst deterioration determination in-operation flag F_MIDCAT is set to 1 (NO to the steps 192 to 194; the step 188), whereby the catalyst deterioration determination operation is started.

Note that although the above-described example of the operation illustrated in FIG. 20 is the example of the case where the three determination operations involving the purge cut are performed in the order D (the EGR failure determination operation→the AF variation determination operation→the sensor failure determination operation), as is apparent from the above-described steps executed in the second continuous execution permission process, the execution of the catalyst deterioration determination operation is inhibited in the same manner also in the case where the three determination operations involving the purge cut are performed in any one of the orders A to C.

Further, FIG. 21 shows an example of changes in the timer values tLAF1 and tLAF2 of the first and second wait timers in the case where the sensor failure determination operation is executed following the AF variation determination operation.

As shown in FIG. 21, during execution of the AF variation determination operation (time point t25 and thereafter, F_MIDDIS=1), when the sensor failure determination execution condition is satisfied (time point t26, F_MCNDLAF←1), the timer value tLAF1 of the first wait timer set in the stabilization time TMSTE starts to be counted down from the time point. Then, after the lapse of the stabilization time TMSTE from the satisfaction of the sensor failure determination execution condition (time point t27 and thereafter, YES to the step 91 in FIG. 8), the timer value tLAF2 of the second wait timer is set to the initial wait time TMLINT or the reduced wait time TMLDEC (the steps 94 and 95).

In this case, since the AF variation determination operation is being executed and the purge cut flag F_PURCUT is equal to 1, the timer value tLAF2 is set to the reduced wait time TMLDEC which is the shorter. When the AF variation determination operation is completed (time point t28, F_MIDDIS←0), in accordance therewith, the sensor failure determination operation is started (F_MIDLAF←1) and the timer value tLAF2 starts to be counted down.

In this connection, although FIG.21 shows the example of the changes in the timer values tLAF1 and tLAF2 in the case where the sensor failure determination operation is executed following the AF variation determination operation, also in cases where combinations of two of the three determination operations involving the purge cut are sequentially and continuously executed, associated ones of the time values tDIS1, tDIS2, tLAF1, tLAF2, tEGR1, and tEGR2 are changed in the same manner.

Further, the purge cut flag F_PURCUT is reset to 0 at the start of the engine 3, and hence when a first one of the three determination operations involving the purge cut is started, the purge cut flag F_PURCUT is still set to 0. This makes the answers to the questions of the step 26 in FIG. 5, the step 92 in FIG. 8, and the step 132 in FIG. 10 negative (NO), so that the time value tDIS2, tLAF2, or tEGR2 of the second wait timer associated with the first determination operation is set to the initial wait time TMDINT, TMLINT, or TMEINT (the step 28, 94, or 134), and the first determination operation is immediately started.

Further, FIG. 22(A) shows changes in the purge flow rate QPU and so forth in a comparative example, and FIG. 22(B) shows changes in the purge flow rate QPU and so forth in the case where the three determination operations involving the purge cut are sequentially and continuously executed by the first embodiment. In the comparative example, differently from the first embodiment, a next determination operation is started after waiting for the stabilization time TMSTE to elapse after the termination of each of the three determination operations involving the purge cut, so that the three determination operations involving the purge cut are not sequentially and continuously executed. Further, before the stabilization time TMSTE elapses, the purge cut is released, causing the evaporated fuel processor 31 to supply evaporated fuel.

For this reason, as shown in FIG. 22(A), in the comparative example, during execution of the second and third determination operations, determination has to be held until the purge flow rate QPU is stabilized to 0, so that time periods required for the second and third determination operations (hereinafter referred to as the “second determination operation time period” and the “third determination operation time period”, respectively) TM2ndC and TM3rdC become longer. As a consequence, it takes a longer time to perform all the three determination operations involving the purge cut.

On the other hand, according to the first embodiment, as described heretofore, the three determination operations involving the purge cut are sequentially and continuously executed, and in this case, the purge cut is continued after the start of the first determination operation until the termination of the third determination operation, whereby the purge flow rate QPU is held at 0. With this, as shown in FIG. 22(B), the second and third determination operation time periods TM2ndC and TM3rdC become shorter than in the case of the above-described example, so that a time period required for all the three determination operations involving the purge cut becomes shorter. This makes it possible to shorten a time period required for executing the purge cut, and hence it is possible to supply more evaporated fuel to the intake passage 21 by a time period indicated by hatching in FIG. 22(B).

Further, correspondence between the various types of elements of the first embodiment and various types of elements of the present invention is as follows: The engine 3, the EGR device 51, and the LAF sensor 66 in the first embodiment correspond to a plurality of devices in the present invention, and correspond to a first or second device in the present invention. Further, the EGR device 51 and the LAF sensor 66 of the first embodiment correspond to another device in the present invention, the three-way catalyst 28 in the first embodiment corresponds to the plurality of devices, the other device, and a third device in the present invention, and the first and second motors 4, 5 in the first embodiment correspond to an electric motor in the present invention. Furthermore, the ECU 2 in the first embodiment corresponds to first determination means, second determination means, third determination means, inhibition means, and determining parameter acquisition means in the present invention.

As described above, according to the first embodiment, the AF variation determination operation, the sensor failure determination operation, and the EGR failure determination operation are executed in the purge cut state, when a predetermined AF variation determination execution condition is satisfied, when a predetermined sensor failure determination execution condition is satisfied, and when a predetermined EGR failure determination execution condition are satisfied, respectively. Further, when a predetermined catalyst deterioration determination execution condition is satisfied, the catalyst deterioration determination operation is executed without requiring the purge cut as the condition.

Furthermore, as described with reference to FIG. 20 and so forth, during execution of a first determination operation of the three determination operations involving the purge cut, when both of an execution condition associated with a second determination operation and the catalyst deterioration determination execution condition are satisfied, the catalyst deterioration determination operation is inhibited from being executed following the completion of the first determination operation in order to give priority to the second determination operation. As a consequence, following the completion of the first determination operation requiring the purge cut as the condition, the second determination operation also requiring the purge cut as the condition is executed.

Further, in a case where the first determination operation is completed, if the execution condition associated with the second determination operation has been satisfied, the second determination operation is started with the purge cut being continued. As a consequence, differently from the above-described conventional case, the supply of evaporated fuel is prevented from being resumed after the completion of the first determination operation until the start of the second determination operation, so that it is not required to hold the determination until the amount of supply of evaporated fuel is stabilized to 0 by the purge cut, and therefore it is possible to determine an abnormality (failure) of a device associated with the second determination operation soon. This makes it possible to shorten a time period required for the three determination operations involving the purge cut, as a whole, thereby making it possible to increase the frequency of execution of the determination operation, and improve the throughput of the evaporated fuel processor 31 for processing evaporated fuel.

Furthermore, the AF variation determination execution condition, the sensor failure determination execution condition, and the EGR failure determination execution condition, which are different from each other, are set as the execution conditions for the AF variation determination operation, the sensor failure determination operation, and the EGR failure determination operation, respectively. The AF variation determination operation includes the air-fuel ratio control intended for determination and the EGR stop control, the sensor failure determination operation includes the injection control intended for determination and normal EGR control, and the EGR failure determination operation includes air-fuel ratio feedback control and the EGR control intended for determination. The three determination operations involving the purge cut thus include control operations for controlling the engine 3, respectively.

As described above, the EGR failure determination execution condition includes the condition b3 that exhaust gases has been recirculated by the EGR device 51 before the start of the EGR failure determination operation (or, recirculation of exhaust gases can be executed) (the step 121 in FIG. 10), and during execution of the AF variation determination operation, the recirculation of exhaust gases by the EGR device 51 is stopped (the step 65 in FIG. 7). Therefore, during execution of the sensor failure determination operation as the first determination operation of the three determination operations involving the purge cut, when both of the AF variation determination execution condition and the EGR failure determination execution condition are satisfied, if the AF variation determination operation is executed following the completion of the sensor failure determination operation, the EGR failure determination execution condition is not satisfied during execution of the AF variation determination operation. As a result, it becomes impossible to perform the EGR failure determination operation following the completion of the AF variation determination operation.

On the other hand, during execution of the EGR failure determination operation, the EGR control valve opening OEV is repeatedly controlled to open and close the EGR control valve 53 a plurality of times at the fixed repetition period, whereby the recirculation of exhaust gases by the EGR device 51 and the stop thereof are repeated, whereas the AF variation determination execution condition includes no condition concerning the recirculation of exhaust gases. For this reason, during execution of the sensor failure determination operation as the first determination operation, when both of the AF variation determination execution condition and the EGR failure determination execution condition have been satisfied, if the EGR failure determination operation is executed following the completion of the sensor failure determination operation, the AF variation determination execution condition can be satisfied during execution of the EGR failure determination operation, whereby it is possible to perform the AF variation determination operation following the completion of the EGR failure determination operation.

Based on the above-described relationship between the EGR failure determination execution condition and AF variation determination execution condition, and the EGR failure determination operation and AF variation determination operation, during execution of the sensor failure determination operation as the first determination operation, when both of the AF variation determination execution condition and the EGR failure determination execution condition have been satisfied, the AF variation determination operation is inhibited from being executed following the completion of the sensor failure determination operation (see FIG. 18). With this, the EGR device 51 is selected as a device for determining an abnormality following the completion of the sensor failure determination operation, so that it is possible to sequentially and continuously execute the EGR failure determination operation and the AF variation determination operation, which makes it possible to shorten a time period required for the EGR failure determination operation and the AF variation determination operation, as a whole.

Furthermore, after the initial wait time TMDINT or the reduced wait time TMDDEC has elapsed after the start of the AF variation determination operation, an AF variation is determined based on the calculated AF variation-determining parameter JUDDIS. Further, after the initial wait time TMLINT or the reduced wait time TMLDEC has elapsed after the start of the sensor failure determination operation, a failure of the LAF sensor 66 is determined based on the calculated integral value LAFDLYP. Furthermore, after the initial wait time TMEINT or the reduced wait time TMEDEC has elapsed after the start of the EGR failure determination operation, a failure of the EGR device 51 is determined based on the calculated integral value RT80AX.

Further, as described with reference to FIG. 21, when the second determination operation is executed following the completion of the first determination operation, each wait time is reduced by using an associated one of the reduced wait times TMDDEC, TMLDEC, and TMEDEC, which are the shorter, so that it is possible to effectively obtain the above-described advantageous effect, i.e. the advantageous effect that it is possible to shorten the time period required for the three determination operations involving the purge cut, as a whole.

Furthermore, the AF variation determination execution condition, the sensor failure determination execution condition, and the EGR failure determination execution condition are different from each other, and each execution condition includes predetermined engine operating conditions concerning the engine speed NE and the intake air amount GAIR (the conditions a1, b1, and c1). Further, as described with reference to FIG. 12, the engine 3 is controlled such that not only engine operating conditions associated with the first determination operation but also engine operating conditions associated with the second determination operation are satisfied during execution of the first determination operation. Therefore, it is possible to enhance the possibility of executing the second determination operation following the completion of the first determination operation, which in turn makes it possible to effectively obtain the above-described advantageous effect, i.e. the advantageous effect that it is possible to shorten the time period required for the three determination operations involving the purge cut, as a whole.

Further, during the above-described control of the engine 3, when the motive power of the engine 3 is smaller than motive power demanded by the driver, electric power corresponding to an insufficient amount of motive power is supplied from the battery 8 to the second motor 5. On the other hand, when the motive power of the engine 3 is larger than the demanded motive power, electric power of the electric power generated by the first motor 4, corresponding to an excess amount of motive power, is charged into the battery 8. From the above, it is possible to ensure excellent drivability.

Further, FIG. 23 shows an example of operation by a variation of the above-described engine operating point control process. In the figure, F_MOE2nd is a second partial execution condition satisfaction flag, and indicates that the above-described conditions (e.g. the above-described conditions b1 to e1 and the like, hereinafter referred to as the “second partial execution conditions”) concerning the parameters and the like other than the operating point (NE, GAIR) of the engine 3, out of the execution conditions associated with a second determination operation, by 1.

Further, in FIG. 23, NELOW1 is a threshold value on a lower side of the engine speed NE, which defines one of the regions α to γ, which is associated with a first determination operation (hereinafter referred to as the “first rotational speed threshold value”). NELOW2 is a threshold value on the lower side of the engine speed NE, which defines one of the regions α to γ, which is associated with a second determination operation (hereinafter referred to as the “second rotational speed threshold value”). Furthermore, a thick two-dot chain line indicates changes in the engine speed NE in a case where the engine operating point control process by the variation is not performed.

As shown in FIG. 23, in the variation of the engine operating point control process, during execution of the first determination operation (time point t29 and thereafter, F_MID1st=1), differently from the first embodiment, the throttle valve opening is controlled such that the operating point of the engine 3 falls within only the one of the regions α to γ, which is associated with the first determination operation. This causes the engine speed NE to be held constant in a state in which the engine speed NE is higher than the first rotational speed threshold value NELOW1,and is at the same time lower than the second rotational speed threshold value NELOW2.

Further, during execution of the first determination operation, when the second partial execution conditions are satisfied (time point t30, F_MOE2nd←1), and further when the first determination operation has been completed in this state (time point t31, F_MOE2nd=1, F_MID1st←0), the throttle valve opening is controlled such that the operating point of the engine 3 falls within the region associated with the second determination operation. This causes the engine speed NE to be held constant in a state in which the engine speed NE is higher than the second rotational speed threshold value NELOW2.

Furthermore, the purge cut flag F_PURCUT is held at 1 insofar as the second partial execution conditions are satisfied (F_MOE2nd=1) even after the first determination operation is completed.

Next, a description will be given of an abnormality determination device according to a second embodiment of the present invention. Compared with the first embodiment, the abnormality determination device according to the second embodiment is different only in an operating region correction process shown in FIG. 24 is performed in place of the above-described engine operating point control process (FIG. 12). The operating region correction process is for performing expansion correction of the region α, the region β, and the region γ in the above-described operating point determination map shown in FIG. 16, as deemed appropriate, so as to make the execution conditions for a determination operation to be executed next easier to be satisfied, during execution of the first and second determination operations of the three determination operations involving the purge cut, and is repeatedly performed at the above-mentioned predetermined repetition period in parallel with the process shown in FIG. 4. In FIG. 24, the same steps as those in FIG. 12 are denoted by the same step numbers. The following description is given mainly of different points from the first embodiment.

As shown in FIG. 24, if the answer to the question of the step 162 is negative (NO) (F_MID3rd=0), i.e. if the AF variation determination operation as the first or second determination operation is being executed, in order to increase the possibility of the sensor failure determination operation being executed continuously from the completion of the AF variation determination operation, β expansion correction is performed (step 231), followed by terminating the present process. In the β expansion correction, the region β in the operating point determination map is corrected such that the region β is expanded with respect to both the engine speed NE and the intake air amount GAIR. In FIG. 25, a two-dot chain line indicates the region β before being subjected to the expansion correction (the same as the region β indicated by the one-dot chain line in FIG. 16), and a solid line indicates the region β after being subjected to the expansion correction.

On the other hand, if the answer to the question of the step 162 is affirmative (YES) (F_MID3rd=1), i.e. if the AF variation determination operation as a third determination operation is being executed, the present process is immediately terminated.

If the answer to the question of the step 166 is affirmative (YES) (F_MID1st=1), i.e. if the sensor failure determination operation as the first determination operation is being executed, in order to increase the possibility of the EGR failure determination operation being executed continuously from the completion of the sensor failure determination operation, γ expansion correction is performed (step 232), followed by terminating the present process. In the γ expansion correction, the region γ in the operating point determination map is corrected such that the region γ is expanded with respect to both the engine speed NE and the intake air amount GAIR. In FIG. 26, a two-dot chain line indicates the region γ before being subjected to the expansion correction (the same as the region γ indicated by the two-dot chain line in FIG. 16), and a solid line indicates the region γ after being subjected to the expansion correction.

Further, if the answer to the question of the step 168 is negative (NO) (F_MId2nd=0), i.e. if the sensor failure determination operation as the third determination operation is being executed, the present process is immediately terminated.

Further, if the answer to the question of the step 169 is affirmative (YES) (F_DONDIS=1), i.e. if the AF variation determination operation as the first determination operation has been completed, and also the sensor failure determination operation as the second determination operation is being executed, the step 232 (the γ expansion correction) is executed, followed by terminating the present process.

On the other hand, if the answer to the question of the step 169 is negative (NO) (F_DONDIS=0), i.e. if the EGR failure determination operation as the first determination operation has been completed, and also the sensor failure determination operation as the second determination operation is being executed, in order to increase the possibility of the AF variation determination operation being executed following the completion of the sensor failure determination operation, a expansion correction is performed (step 233), followed by terminating the present process. In the a expansion correction, the region α in the operating point determination map is corrected such that the region α is expanded with respect to both the engine speed NE and the intake air amount GAIR. In FIG. 27, a two-dot chain line indicates the region α before being subjected to the expansion correction (the same as the region α indicated by a solid line in FIG. 16), and a solid line indicates the region α after being subjected to the expansion correction.

Further, if the answer to the question of the step 172 is affirmative (YES), i.e. if the EGR failure determination operation as the first determination operation is being executed, in order to increase the possibility of the AF variation determination operation or the sensor failure determination operation being executed following the completion of the EGR failure determination operation, α β expansion correction is performed (step 234), followed by terminating the present process. In the α β expansion correction, one of the region α and the region β closer to the operating point of the engine 3 at the time is subjected to the expansion correction. Further, when the operating point of the engine 3 at the time falls not only within the region γ but also within the region α and/or the region β, one(s) of the regions α and β within which the operating point of the engine 3 falls is/are subjected to the expansion correction. A method of the expansion correction thereof is the same as the method described in the steps 231 and 233.

Further, if the answer to the question of the step 174 is affirmative (YES) (F_MID2nd=1), i.e. if the EGR failure determination operation is being executed as the second determination operation, the step 233 is executed (the α expansion correction is executed), followed by terminating the present process.

On the other hand, if the answer to the question of the step 174 is negative (NO), i.e. if the EGR failure determination operation as the third determination operation is being executed, the present process is immediately terminated.

As described hereinabove, according to the second embodiment, one of the region α, the region β, and the region γ, associated with the second determination operation, is subjected to the expansion correction during execution of the first determination operation of the three determination operations involving the purge cut, whereby the execution conditions associated with the second determination operation are loosened. This makes it possible to enhance the possibility of sequential and continuous execution of the first and second determination operations, thereby making it possible to more effectively obtain the above-described advantageous effect, i.e. the advantageous effect that it is possible to shorten the time period required for the three determination operations involving the purge cut, as a whole.

Note that although in the second embodiment, the conditions a1, a2, and a3 concerning the operating point (NE, GAIR) of the engine 3, included in the AF variation determination execution condition, the sensor failure determination execution condition, and the EGR failure determination execution condition, are loosened, it is to be understood that the other conditions included in each of the AF variation determination execution condition, the sensor failure determination execution condition, and the EGR failure determination execution condition may be loosened.

Note that the present invention is by no means limited to the above-described first and second embodiments (hereinafter, collectively referred to as the “embodiments”), but can be practiced in various forms. For example, although in the embodiments, the plurality of devices of the present invention are the EGR device 51 and the LAF sensor 66, they may be any other suitable devices, such as the injector 26 and the evaporated fuel processor 31, provided in association with the internal combustion engine. Further, although in the embodiments, the number of the plurality of devices is four, it may be three or five or more.

Furthermore, although in the embodiments, the order of the three determination operations involving the purge cut is limited to the order A to the order D, it is to be understood that due to the relationship between the conditions for executing the respective determination operations and the control operations of the engine in the respective determination operations, the three determination operations may be performed in the order of satisfaction in a case where they can be continuously executed in a desired order. In this case, the above-described engine operating point control process is performed e.g. in the following manner:

The throttle valve opening is controlled such that during execution of each of the three determination operations involving the purge cut, the operating point of the engine falls within a region in which out of the plurality of regions defined by the operating point determination map, a region associated with the determination operation in execution and a region, which is other than the associated region and is at the same time closest to the operating point of the engine at the time, overlap each other. Further, when the operating point of the engine falls within the region in which the region associated with the determination operation in execution and the region other than the associated region overlap each other, the throttle valve opening is controlled to hold the state.

Further, in a case where the three determination operations including the purge are continuously executed in a desired order as described above, the operating region correction process is performed e.g. in the following manner: During execution of each of the three determination operations involving the purge cut, one of the plurality of regions defined by the operating point determination map, which is other than a region associated with the determination operation in execution, and is at the same time closest to the operating point of the engine at the time, is subjected to expansion correction. Further, when the operating point of the engine falls within the region in which the region associated with the determination operation in execution and the region other than the associated region overlap each other, the region other than the associated region is subjected to correction expansion.

Furthermore, although in the embodiments of the present invention, the control operations of the engine included in the second determination operation are the EGR stop control (the step 65 in FIG. 7) and the EGR control intended for determination (the step 144 in FIG. 11), any other suitable control operations may be included. Furthermore, although in the embodiments, the engine 3, which is a gasoline engine for a vehicle V, is used as the internal combustion engine of the present invention, any other suitable internal combustion engine, such as a diesel engine, an LPG engine, an engine for boats, or an engine for aircraft, may be used.

Furthermore, although the embodiments are examples in which the present invention is applied to the vehicle V, which is configured to be capable of connecting/disconnecting between the engine 3 and the front wheels WF, and in which the first motor 4 is connected to the engine 3 and the second motor 5 is connected to the front wheels WF, the present invention may also be applied to a vehicle, in which an internal combustion engine is connected to drive wheels via a transmission, and an electric motor is connected to the drive wheels via the transmission or without via the transmission. Furthermore, although the embodiments are examples in which the present invention is applied to a hybrid vehicle V including the engine 3 and the first and second electric motors 4 and 5 as motive power sources, the present invention may also be applied to a vehicle which includes only an internal combustion engine as a motive power source. In this case, the engine operating point control process may be omitted. The above variations of the embodiments can be applied in a combined manner, as required. It is to be further understood that various changes and modifications may be made without departing from the spirit and scope of the invention.

### REFERENCE SIGNS LIST

2 ECU (first determination means, second determination means, third determination means, inhibition means, determining parameter acquisition means)

3 engine (a plurality of devices, first device, second device)

4 first motor (electric motor)

5 second motor (electric motor)

21 intake passage (intake system)

28 three-way catalyst (a plurality of devices, other device, third device)

FT fuel tank

31 evaporated fuel processor

51 EGR device (a plurality of devices, other device, first device, second device)

66 LAF sensor (a plurality of devices, other device, first device, second device)

JUDDIS AF variation-determining parameter (determining parameter)

LAFDLYP integral value (determining parameter)

RT80AX integral value (determining parameter)

TMDINT initial wait time (wait time)

TMLINT initial wait time (wait time)

TMEINT initial wait time (wait time)

TMDDEC reduced wait time (wait time)

TMLDEC reduced wait time (wait time)

TMEDEC reduced wait time (wait time)

1. An abnormality determination device for determining abnormalities of a plurality of devices including an internal combustion engine provided with an evaporated fuel processor that traps evaporated fuel generated in a fuel tank and supplies the trapped evaporated fuel to an intake system of the engine, and other devices provided in association with the engine, comprising:
first determination means for performing a first determination operation for determining an abnormality of a first device of the plurality of devices, in a state in which the supply of evaporated fuel by the evaporated fuel processor is stopped, when a predetermined first execution condition is satisfied; and
second determination means for performing a second determination operation for determining an abnormality of a second device of the plurality of devices, distinct from the first device, in the state in which the supply of evaporated fuel by the evaporated fuel processor is stopped, when a predetermined second execution condition is satisfied,
wherein in a case where the first determination operation is completed, when the second determination condition has been satisfied, said second determination means starts the second determination operation, with the supply of evaporated fuel being held in the stopped state.

2. The abnormality determination device according to claim 1, wherein the second device is formed by a plurality of second devices distinct from each other,
wherein a plurality of second execution conditions different from each other are set for the plurality of second devices, respectively, as the second execution condition,
wherein a plurality of second determination operations different from each other are set for the plurality of second devices, respectively, as the second determination operation, each of the plurality of second determination operations including a control operation for controlling the engine, and
wherein during execution of the first determination operation, when all of the plurality of second execution conditions are satisfied, said second determination means selects the second device of which an abnormality is to be determined following the completion of the first determination operation, from the plurality of second devices, based on the plurality of second execution conditions and the plurality of second determination operations.

3. The abnormality determination device according to claim 1, further comprising:
third determination means for performing a third determination operation for determining an abnormality of a third device of the plurality of devices, distinct from the first and second devices, when a predetermined third execution condition is satisfied, and
inhibition means for inhibiting the third determination operation from being executed continuously from the completion of the first determination operation in order to give priority to the second determination operation, when both of the second and third execution conditions have been satisfied during execution of the first determination operation.

4. The abnormality determination device according to claim 1, further comprising determining parameter acquisition means for acquiring a determining parameter for determining an abnormality of each of the plurality of devices,
wherein said second determination means determines an abnormality of the second device based on the acquired determining parameter after the lapse of a predetermined wait time after a start of the second determination operation, and reduces the wait time when the second determination operation is executed following the completion of the first determination operation.

5. The abnormality determination device according to claim 1, wherein an electric motor that forms motive power sources together with the engine is connected to the engine,
wherein the first and second execution conditions include predetermined first and second engine operating conditions concerning a operating state of the engine, different from each other, respectively, and
wherein during execution of the first determination operation, said second determination means controls the engine such that not only the first engine operating condition but also the second engine operating condition is satisfied.

6. The abnormality determination device according to claim 1, wherein during execution of the first determination operation, said second determination means loosens the second execution condition.
